(19) United States
(12) Patent Application Publication
(10) Pub. No.: US 2026/0285721 A1
(43) Pub. Date: Sep. 24, 2026

(54) WATER OXIDATION SYSTEM

(71) Applicant: Oxidian Labs, LLC, Omaha, NE (US)

(72) Inventors: Mike WELNIAK, Omaha, NE (US); Steve FALLER, Omaha, NE (US); Jana FALLER, Omaha, NE (US); Noah Robert Burk, Jackson, MI (US); Ruben Inzunza, Mesa, AZ (US); Bryan Richard Falk, Chandler, AZ (US); Brian Aaron Whipple, Maricopa, AZ (US)

(21) Appl. No.: 19/574,223

(22) Filed: Mar. 20, 2026

Related U.S. Application Data
(60) Provisional application No. 63/775,891, filed on Mar. 21, 2025.

(51) Int. Cl. C02F 1/78; B01F 23/2326; B01F 25/312; B01F 35/71; B01F 101/00

(52) U.S. Cl. CPC C02F 1/78; B01F 23/2326; B01F 25/312; B01F 35/71805; B01F 2101/305; C02F 2307/12

(57) ABSTRACT

Disclosed herein, is a system for producing treated water for use in a downstream equipment, such as a washing machine, or a fill station. The system may include two separate flow paths depending on the use for the treated water, each flow path configured to output the treated water at different flow rates in view of the different consumption rates for the end uses. The system may be configured to treat the water using ozone, which may be mixed with water flowing through a respective flow path. Each flow path may include a mixing device configured to provide a motive force for air to flow from an ambient surrounding, through a generator to produce ozone, and then to the mixing device to mix with the water. The system may further include an actuator configured to toggle between a first flow path operation and a second flow path operation.

### CROSS-REFERENCE TO RELATED APPLICATIONS

The entire contents of the following application are incorporated by reference herein: U.S. Provisional Patent Application No. 63/775,891, filed March 21, 2025, and entitled WATER OXIDATION SYSTEM.

### TECHNICAL FIELD

The present disclosure relates to oxidating water. Specifically, the present disclosure relates to oxidating water for cleaning purposes.

### BACKGROUND

In water oxidation, water (H₂O) molecules lose electrons to form oxygen gas (O₂), protons (H⁺), and electrons (e⁻). This reaction is a key part of photosynthesis, where plants use sunlight to split water, releasing oxygen and providing electrons and protons to produce energy-rich molecules like adenosine triphosphate (ATP) and nicotinamide adenine dinucleotide phosphate (NADPH). These molecules fuel the synthesis of sugars, which are useful for plant growth and life on Earth.

Oxidating water can play a role in water purification and disinfection. By generating reactive oxygen species or free oxygen, this process helps break down pollutants or kill pathogens in contaminated water, contributing to environmental cleanup and public health.

### SUMMARY

The foregoing, and other features and advantages of the invention, will be apparent from the following, more particular description of the preferred embodiments of the invention, the accompanying drawings, and the claims.

Included in the present disclosure is a system including, a first inlet configured to receive a liquid from a first external source and a second inlet configured to receive a gas from a second external source. In some embodiments, the system includes a generator fluidly coupled with the second inlet and configured to process the gas so as to generate a processed gas. The system may include a first mixing device disposed along a first flow path. The first mixing device may be configured to mix the liquid and the processed gas, so as to produce a treated liquid. The first mixing device may be configured to output the treated liquid at a first flow rate. According to some embodiments, the system includes a second mixing device disposed along a second flow path, the second mixing device configured to mix the liquid and the processed gas, so as to produce the treated liquid, the second mixing device configured to output the treated liquid at a second flow rate that is different than the first flow rate, wherein at least a portion of the first flow path is parallel with at least a portion of the second flow path. The system may include an actuator configured to toggle between a first flow path operation and a second flow path operation. In some embodiments, under the first flow path operation, the liquid and the processed gas pass through the first mixing device. Under the second flow path operation, the liquid and the processed gas may pass through the second mixing device. In some embodiments, the system includes a first outlet for dispensing the treated liquid to a first external location.

The first flow path may may include a first control valve. The second flow path may include a second control valve, such that toggling between the first flow path operation and the second flow path operation may include adjusting an open position of the first control valve, the second control valve, or both. According to some embodiments, the system adjusting the open position includes, transitioning the first control valve, the second control valve, or both, to an open position to allow the liquid or the treated liquid to pass therethrough, transitioning the first control valve, the second control valve, or both, to a closed position to prevent or reduce an amount of the liquid or the treated liquid to pass therethrough, or both. In some embodiments, the actuator is communicatively coupled with the first control valve, the second control valve, or both, so as to enable adjusting the open position of the first control valve, the second control valve, or both.

The treated gas produced by the first mixing device may be molecularly different from the treated gas produced by the second mixing device. According to some embodiments, the treated gas produced by the first mixing device is molecularly the same or substantially the same as the treated gas produced by the second mixing device. In some embodiments, the first external source is configured to provide the liquid in a pressurized state, thereby providing the motive force of the liquid to flow through the system when the external source has a pressure higher than a pressure of the first external location.

In some embodiments, first mixing device, the second mixing device, or both, includes a venturi injector, a venturi valve, a venturi orifice, or any combination thereof. The first mixing device, the second mixing device, or both, may include a gas suction inlet fluidly coupling the generator to the liquid flowing in the system, the gas suction inlet disposed about the low pressure zone. The first mixing device, the second mixing device, or both, may include a tee connection. In some embodiments, the gas suction inlet is oriented in a direction that is perpendicular or substantially perpendicular to the liquid flow in the tee connection. According to some embodiments, the first mixing device, the second mixing device, or both, the orifice is disposed upstream of the tee connection. The orifice and the tee connection of the first mixing device, the second mixing device, or both, may be a singular component, or may be separable components coupled together.

According to some embodiments, the orifice of the first mixing device includes a cross-sectional area that is from about 0.5 to about 5.0 times in size compared to a cross-sectional area of the orifice of the second mixing device, such that the first flow rate is larger than the second flow rate according to a cross-sectional area size proportional increase in volumetric flow. The orifice of the first mixing device may include a cross-sectional area that is from about 1.0 to about 3.0 times in size compared to a cross-sectional area of the orifice of the second mixing device, such that the first flow rate may be larger than the second flow rate according to a cross-sectional area size proportional increase in volumetric flow. According to some embodiments, the orifice of the first mixing device includes a cross-sectional area that is from about 1.5 to about 2.0 times in size compared to a cross-sectional area of the orifice of the second mixing device, such that the first flow rate is larger than the second flow rate according to a cross-sectional area size proportional increase in volumetric flow.

The system may include a control device in fluidic communication with a treated liquid sensor, the treated liquid sensor configured to detect a property of the treated liquid. The property of the treated liquid may include an oxidation-reduction potential. In some embodiments, the treated liquid sensor is in communication with a display panel, an LED module, or both. The treated liquid sensor may be configured to indicate whether the property of the treated liquid is above a minimum threshold. The control device may include a chamber configured to receive the treated liquid from the first flow path, the second flow path, or both. The treated liquid sensor may be configured to be exposed in the chamber, in fluidic communication with the chamber, or both. According to some embodiments, the system includes an output tube fluidly coupling the control device with the first outlet. The first flow path may be a first portion of the first flow path, and the output tube may be a second portion of the first flow path. The system may include a second outlet for dispensing the treated liquid to a second external location.

In some embodiments, the system includes an elbow tube fluidly coupling the control device with the second outlet. According to some embodiments, the second flow path is a first portion of the second flow path, and the elbow tube is a part of a second portion of the second flow path. The second portion of the second flow path further may include a third control valve, such that toggling between the first flow path operation and the second flow path operation may include adjusting an open position of the first control valve, the second control valve, the third control valve, or any combination thereof. In some embodiments, the first flow path operation includes the first control valve to be in the open position to allow the liquid or the treated liquid to pass therethrough, and the second control valve and the third control valve to be in the closed position to prevent or reduce an amount of the liquid or the treated liquid to pass therethrough. The second flow path operation may include the first control valve to be in the closed position to prevent or reduce the liquid or the treated liquid to pass therethrough, and may include the second control valve and may include the third control valve to be in the open position to allow the liquid or the treated liquid to pass therethrough.

According to some embodiments, the actuator is communicatively coupled with the first control valve, the second control valve, the third control valve, or any combination thereof, so as to enable adjusting the open position of the first control valve, the second control valve, the third control valve, or any combination thereof.

The first external location may include a washing machine, a sink unit, a dishwasher, a hose, or any combination thereof. The second outlet may include a hose or nozzle. In some embodiments, the system includes a magnet configured to couple with the hose or nozzle. The second external location may include a bucket, bottle, a container, or any combination thereof.

In some embodiments, the generator includes a first generator and a second generator fluidly coupled with the first generator. The first generator and the second generator may be coupled in series, such that the gas may be configured to flow from the second inlet to the first generator to the second generator and then to one or both of the first mixing device and the second mixing device. The system may include a gas container fluidly coupled with the second inlet, the container configured to dry or at least partially dry the gas. The gas container may include desiccant material. According to some embodiments, the system includes a y-valve configured to divert a flow of the processed gas from the generator to the first mixing device, the second mixing device, or both.

The system may include a flow sensor configured to measure a flow rate of the liquid passing through the first inlet. The flow sensor may be communicatively coupled with a display, such that the display is configured to display the measured flow rate.

According to some embodiments, the system includes a front cover and a rear cover configured to couple to the front cover, so as to define an interior portion, such that the front cover and the rear cover coupled together provide a housing for one or more of the first mixing device, the second mixing device, and the generator. In some embodiments, the system includes an electrical system configured to provide electrical power to the actuator, the first control valve, the second control valve, the third control valve, the generator, the flow sensor, the display, the treated liquid sensor, or any combination thereof.

The generator may be configured to process the gas by exciting the gas. Exciting the gas may be via applying electrical energy, UV light, or both, to the gas. In some embodiments, the gas includes oxygen, where exciting the gas results in at least some of the oxygen to be converted into ozone, such that the processed gas includes ozone. The liquid may be water, such that the treated liquid may be ozonated water. The system may include one or more additional flow paths. Each additional flow path may correspond to an additional outlet for dispensing the treated liquid.

Include in the present disclosure is a system, including a first inlet configured to receive a liquid from a first external source. The system may include a second inlet configured to receive a gas from a second external source. In some embodiments, the system includes a generator fluidly coupled with the second inlet and configured to process the gas so as to generate a processed gas. According to some embodiments, the system includes a mixing device configured to mix the liquid and the processed gas, so as to produce a treated liquid. The system may include a first outlet for dispensing the treated liquid to a first external location.

In some embodiments, the system includes a first flow path configured to deliver the treated liquid to the first outlet, and a second flow path configured to deliver the treated liquid to a second outlet for dispensing the treated liquid to a second external location. The first external location may include a washing machine, a sink unit, a hose, or any combination thereof. According to some embodiments, the second external location includes a bottle, a bucket, a container, or any combination thereof.

The system may include a control device that may be configured to divert a flow of the treated liquid to the first flow path, the second flow path, or both. According to some embodiments, the system includes an actuator configured to actuate the control device so as to divert the flow through only the first flow path, through only the second flow path, or through both the first and second flow paths. The first external source may be configured to provide the liquid in a pressurized state, thereby providing a motive force for the liquid to flow through the system. In some embodiments, the second external source is a surrounding environment of the system. The liquid flowing through the mixing device may create a motive force for the gas to flow through the system.

According to some embodiments, the mixing device includes an orifice that increases a velocity of the liquid, thereby creating a low pressure zone within the mixing device, such that a pressure differential between the second external source and the low pressure zone creates the motive force for the gas. The orifice may include a restriction orifice that may be configured to provide a constricted cross-sectional area relative to an upstream and downstream portion of a flow path. In some embodiments, the mixing device includes a venturi injector, a venturi valve, a venturi orifice, or any combination thereof.

The mixing device may include a tee connection. According to some embodiments, the tee connection is configured to receive the processed gas in a direction that is perpendicular or substantially perpendicular to the liquid flow in the tee connection. In some embodiments, the orifice and the tee connection of the mixing device are a singular component, or separable components coupled together.

The system may include a treated liquid sensor in fluid communication with the treated liquid flow. The treated liquid sensor may be configured to detect a property of the treated liquid. According to some embodiments, the property of the treated liquid includes an oxidation-reduction potential.

The generator may include a first generator and may include a second generator fluidly coupled with the first generator. In some embodiments, the first generator and the second generator are coupled in series, such that the gas is configured to flow from the second inlet to the first generator to the second generator and then to the mixing device.

According to some embodiments, the system includes a gas container fluidly coupled with the second inlet, the container configured to dry or at least partially dry the gas. The gas container may include desiccant material. The generator may be configured to process the gas by exciting the gas. Exciting the gas may be via applying electrical energy, UV light, or both, to the gas.

In some embodiments, the gas includes oxygen, wherein exciting the gas may result in at least some of the oxygen to be converted into ozone, such that the processed gas may include ozone. The liquid may include water, such that the treated liquid may include ozonated water.

Included in the present disclosure is a method, including providing a system and activating the system. Activating the system may include allowing for the first inlet to be in fluid communication with the first external source, wherein the first external source may be pressurized, and may include providing an open or at least partially open path to the first external location, the second external location, or both, so as to create a pressure differential between the first external source and the first external location, the second external location, or both, thereby providing a motive force for the liquid to flow through the system. In some embodiments, the liquid flowing through the system creates the motive force for the gas to flow through the system, such that the gas is processed by the generator, and such that the processed gas is mixed with the liquid to create the treated liquid.

According to some embodiments, the method includes actuating the actuator, thereby diverting the liquid, the gas, and the treated liquid from flowing through the first flow path to the second flow path.

### BRIEF DESCRIPTION OF DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a front view of a water oxidation system, according to some embodiments.

FIG. 2A illustrates a perspective view of the water oxidation system of FIG. 1, according to some embodiments.

FIG. 2B illustrates a perspective view of the water oxidation system of FIG. 2A, further depicting a fluid flow pathway, according to some embodiments.

FIG. 3 illustrates a block diagram depicting the flow pathway of water for the water oxidation system of FIG. 1, according to some embodiments.

FIGS. 4A and 4B illustrate perspective views of the water oxidation system of FIG. 1, further depicting a fluid flow pathway, according to some embodiments.

FIG. 5 illustrates a block diagram depicting a pathway of a gas for the water oxidation system of FIG. 1, according to some embodiments.

FIG. 6 illustrates another block diagram depicting the flow pathway of the water and gas for the water oxidation system of FIG. 1, according to some embodiments.

FIG. 7 illustrates a bottom perspective view of the water oxidation system of FIG. 1 showing a control device, according to some embodiments.

FIG. 8 illustrates a top partial perspective view of the water oxidation system of FIG. 1, according to some embodiments.

FIG. 9 illustrates a perspective view of the water oxidation system of FIG. 1 showing a nozzle, according to some embodiments.

FIG. 10 illustrates a perspective view of the water oxidation system of FIG. 1 showing a nozzle, according to some embodiments.

FIG. 11A illustrates a perspective view of a water oxidation system, according to some embodiments.

FIG. 11B illustrates an additional perspective view of the water oxidation system of FIG. 11A, according to some embodiments.

FIG. 11C illustrates a front view of the water oxidation system of FIG. 11A, according to some embodiments.

FIG. 11D illustrates a rear view of the water oxidation system of FIG. 11A, according to some embodiments.

FIG. 11E illustrates a side view of the water oxidation system of FIG. 11A, according to some embodiments.

FIG. 11F illustrates an additional side view of the water oxidation system of FIG. 11A, according to some embodiments.

FIG. 12A illustrates a front view of the water oxidation system of FIG. 11A, without a front cover, according to some embodiments.

FIG. 12B illustrates arear view of the water oxidation system of FIG. 11A, without a rear cover, according to some embodiments.

FIG. 13A illustrates a front view of the water oxidation system of FIG. 12A, according to some embodiments.

FIG. 13B illustrates a perspective view of the water oxidation system of FIG. 13A, according to some embodiments.

FIG. 13C illustrates an additional perspective view of the water oxidation system of FIG. 13A, according to some embodiments.

FIG. 14 illustrates a perspective view of the water oxidation system of FIG. 13C, further depicting the water flow through the water oxidation system, according to some embodiments.

FIG. 15 illustrates a block diagram depicting the pathway of the water through the water oxidation system of FIG. 14, according to some embodiments.

FIG. 16 illustrates a perspective view of the water oxidation system of FIG. 13A, further depicting the gas flow the water oxidation system, according to some embodiments.

FIG. 17 illustrates a block diagram depicting the pathway of the gas through the water oxidation system of FIG. 13A, according to some embodiments.

FIG. 18 illustrates a block diagram depicting the pathway of the water and gas through the water oxidation system of FIG. 13A, according to some embodiments.

FIG. 19A illustrates a front perspective view of another water oxidation system, without a front or rear cover, according to some embodiments.

FIG. 19B illustrates a partial bottom perspective view of the water oxidation system of FIG. 19A, according to some embodiments.

FIG. 19C illustrates an additional front perspective view of the water oxidation system of FIG. 19A, according to some embodiments.

FIG. 20 illustrates a front perspective view of the water oxidation system of FIG. 19A, further depicting the gas flow through the water oxidation system, according to some embodiments.

FIG. 21 illustrates a front perspective view of the water oxidation system of FIG. 19A, further depicting the water flow through the water oxidation system, according to some embodiments.

FIG. 22 illustrates a block diagram depicting the pathway of the gas and water through the water oxidation system of FIG. 19A, according to some embodiments.

FIG. 23A illustrates a front view of the water oxidation system of FIG. 19A, according to some embodiments.

FIG. 23B illustrates a front view of the water oxidation system of FIG. 19A, without the electrical system cover, according to some embodiments.

FIG. 24A illustrates a front view of the water oxidation system of FIG. 19A, with the front access panel, according to some embodiments.

FIG. 24B illustrates a perspective view of the water oxidation system of FIG. 24A, according to some embodiments.

FIG. 24C illustrates a rear perspective view of the water oxidation system of FIG. 24A, according to some embodiments.

FIG. 25 illustrates a perspective view of another embodiment of a housing for a water oxidation system, according to some embodiments.

### DETAILED DESCRIPTION OF THE INVENTION

Disclosed herein, in some aspects, is a water oxidation system that may be configured to mix a liquid and a gas, resulting in a mixture that is able to sterilize or disinfect articles (e.g., objects, surfaces, foodstuffs, etc.). In some cases, the water oxidation system is configured to mix water with ozone, to thereby generate ozonated water. The ozone may be generated by the water oxidation system. The water may mix with the ozone through one or more mixing valves, which in turn, may help pull a vacuum so as to draw the ozone towards the mixing valve. The water oxidation system may store its contents within a housing of the water oxidation system. Herein, the “water oxidation system” may be referred to as a “system” (which may be, for example, designated with reference character 10, 12, or 14 herein), where the terms may be used interchangeably.

The water oxidation system may be part of a cleaning system that includes an external component (e.g., a washing machine) fluidly coupled to the water oxidation system. The water oxidation system may be configured to be an intermediary device between the external component and fluid resource(s) (e.g., a water source for the washing machine) where the water oxidation system receives the fluid from the resources, processes the fluid, and dispenses the processed to the external component. The water oxidation system may be configured to couple with one or more tubings, hoses, PVC pipes, or other means for transporting a liquid and/or a gas. The water oxidation system may also be confirmed with one or more additional outlet for dispensing the fluid through the outlet, which may be to another external component, and/or a hose (for example). In some cases, the water oxidation system is configured to toggle between dispensing the fluid through different fluid outlets, wherein the water oxidation system may have one or more designated flow paths corresponding to each fluid outlet.

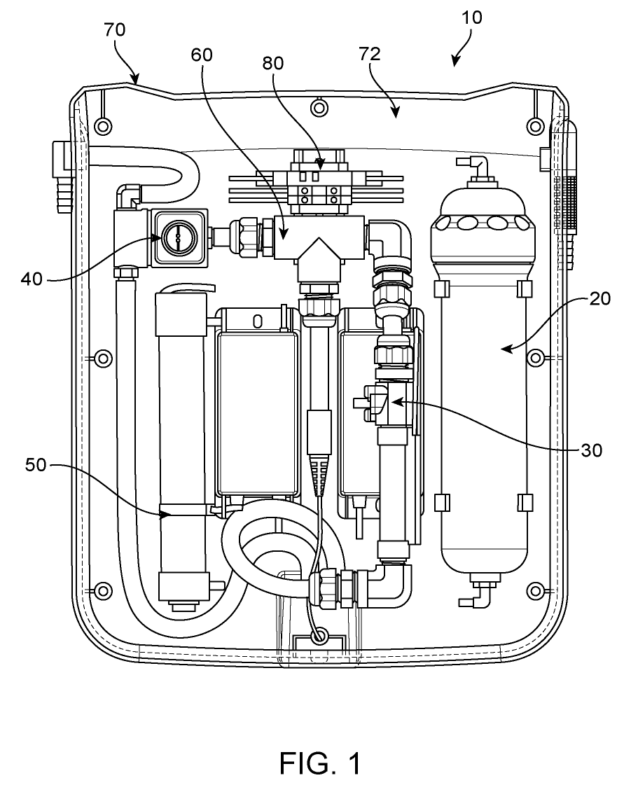

FIG. 1 illustrates a front view of an interior of a water oxidation system 10, according to some embodiments. In the embodiment as shown in FIG. 1, the system 10 is placed on a wall of a building. In additional or alternative embodiments, the system 10 is placed on a side of a washing machine. In some embodiments, system 10 is configured to be mounted under an object (such as a ceiling. The system 10 may also be configured to mount on the side of an object (such as a sink, or a kitchen appliance). In additional or alternative embodiments, the system 10 is configured to be placed on the floor. As shown in FIG. 1, the system 10 may include a housing 70 that covers all of, or a substantial portion of the system 10. The housing 70 may also cover at least a portion of the system 10. According to some embodiments, the housing 70 includes a rear cover and a front configured to couple to the rear cover. The rear cover and the front cover, when coupled to each other, define an interior portion 72, that is, an interior compartment of the housing in which different contents and necessary electronics may be stored. The rear cover and the front cover, when decoupled from one another, may permit a user to adjust and/or rearrange the system 10. In some embodiments, the housing 70 may include an actuator (e.g., a button, a knob, a lever, etc.) configured to activate and deactivate the water oxidation system.

Also shown in FIG. 1 is a container 20 located at least partially within the interior of system 10. The container 20 may be capable of controlling the moisture content of a gas. The container 20 may be removable from the system 10. In additional or alternative embodiments, the container 20 is configured to display the contents of the container 20. In some embodiments, the front cover and/or rear cover is configured to reveal at least a portion of the container 20 for a user to view the container 20.

As shown in FIG. 1, the system 10 includes a generator 50 located at least partially within the interior portion 72. The generator 50 may be fluidly coupled with the container 20.

FIG. 1 also depicts a mixing device 30 located at least partially within the interior portion 72. The mixing device 30 may control the flow of a liquid and/or a gas within the system 10. The mixing device 30 may fluidly couple with a sensor 60 and/or fluidly couple with the generator 50. As shown in FIG. 1, the system 10 further includes a control device 40 that is fluidly coupled with the sensor 60.

Also shown in FIG. 1 is an electrical system 80 located at least partially within the interior portion 72. The electrical system 80 may electrically couple with the generator 50. In some embodiments, the electrical system 80 couples with the sensor 60. In additional or alternative embodiments, the electrical system 80 is configured to house one or more racks. The racks may be configured to couple with a relay.

As described herein, the electrical system 80 may be configured to house an electrical relay. In additional or alternative embodiments, the electrical system 80 is coupled to an external device. In some embodiments, the electrical relay includes a variable valve electrically coupled to an external device. The external device may be an actuator (such as a button). In additional or alternative embodiments, the electrical relay includes a mechanical valve coupled to the external device.

According to additional or alternative embodiments, the electrical system 80 includes an integrated circuit board (ICB). The ICB may be configured to communicate with at least one electrical device. According to some embodiments, the electrical device is an external display. The external display may be communicatively coupled to a meter circuit board and configured to display a measurement from the sensor 60. In additional or alternative embodiments, the ICB is a printed circuit board (PCB). The PCB may be configured to communicate with one or more relays.

In some embodiments, the electrical system 80 includes a power supply. The power supply may be configured to electrically couple with a generator 50 and/or a sensor 60. In additional or alternative embodiments, the power supply is configured to electrically couple with an external device. The external device according to some embodiments, is an external screen, lighting, an actuator (such as a button), or a solenoid powered valve. In some embodiments, the power supply is configured to discharge 12 volts (V) of energy. According to some embodiments, the electrical system 80 provides power to the generator 50, sensor 60, and a display, where the generator 50 and sensor 60 are communicatively coupled to the display, and the display is configured to display a measurement from the sensor 60.

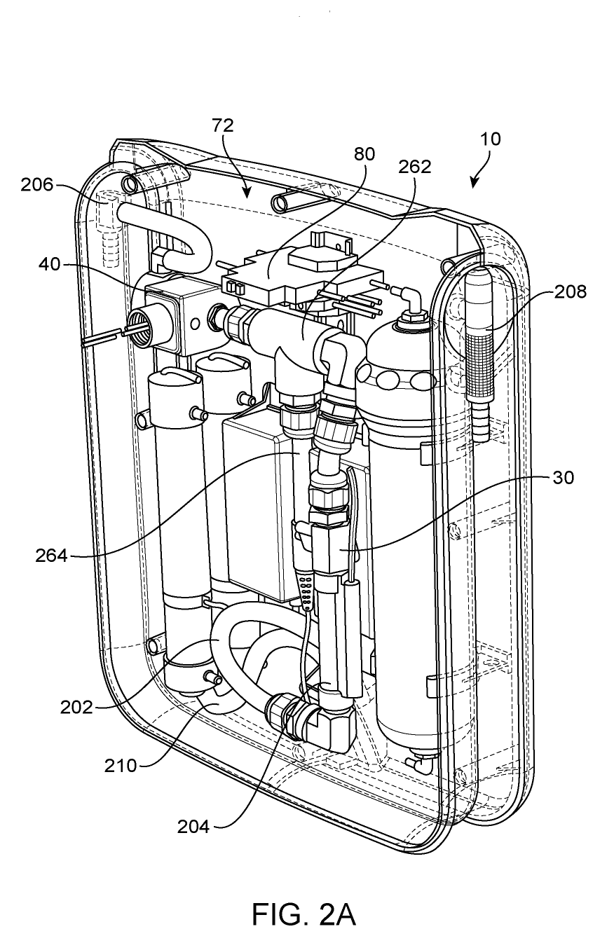

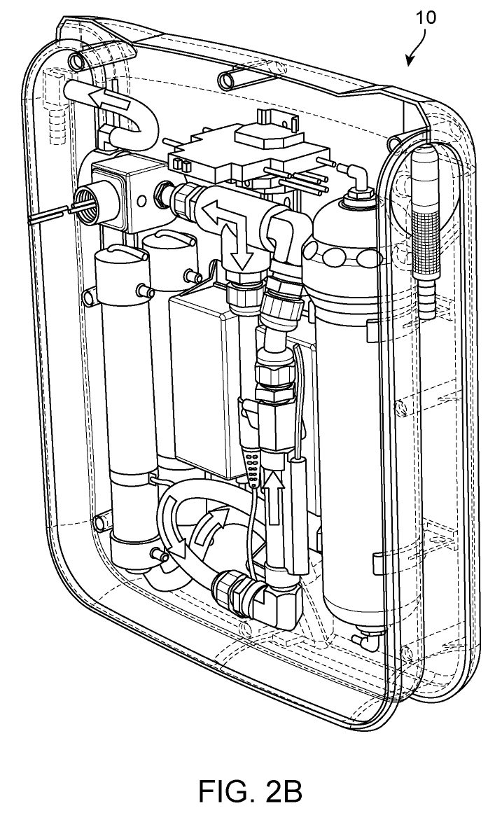

In additional or alternative embodiments, a flow switch (as shown and described in FIG. 2A below) may electrically couple with the electrical system 80. In some embodiments, upon a liquid entering the flow switch, the flow switch communicates with the electrical system 80 and the electrical system 80 provides power to the generator 50. In additional or alternative embodiments, the flow switch communicates with a PCB. According to some embodiments, the water oxidation system includes an actuator (i.e., a push button) that may be configured to trigger a fluid to enter the water oxidation system and flow to the flow switch.

FIG. 2A illustrates a perspective view of a water oxidation system. As shown in FIG. 2A, the system 10 includes a fluid system located at least partially within an interior portion 72. According to some embodiments, the system 10 includes a flow switch 204 fluidly coupled with a fluid inlet tube 202. The fluid inlet tube 202 may be configured to receive a liquid from an external source and transport the liquid to the flow switch 204.

According to some embodiments, the fluid inlet tube 202 is configured to receive water from a cold water supply, such as by way of a public water system. In additional or alternative embodiments, the fluid inlet tube 202 is configured to receive water from a laundry machine water supply. The fluid inlet tube 202 may also include a light emitting diode (LED) that emits a light when a fluid passes through the fluid inlet tube 202.

As depicted in FIG. 2A, the flow switch 204 is electrically coupled with an electrical system 80. According to some embodiments, the flow switch 204 is electrically coupled to the electrical system 80 with a wire. The flow switch 204 may have an on mode wherein a fluid is being transported and activates the electrical system 80, and an off mode wherein a fluid is not being transported and deactivates the electrical system 80. The flow switch 204 as shown in FIG. 2A, fluidly couples with a mixing device 30 located at least partially within the interior portion 72.

The mixing device 30 may be fluidly coupled with and located above the flow switch 204 and receive a liquid from the flow switch 204. In some embodiments, the mixing device 30 is also configured to receive a gas and mix the gas with the liquid from the flow switch 204 to form a mixture. In additional or alternative embodiments, the mixing device 30 mixes ozone gas with water as the liquid to form an ozonated water mixture. The mixing device 30 may create a vacuum within the interior of the mixing device 30 to mix the gas and fluid. In some embodiments, the mixing device 30 includes a vacuum release function that relieves the vacuum. Some benefits of a vacuum release function may include a gas replacing water within the system, and/or allowing the liquid to drain from the mixing device 30 quickly. In some embodiments, the mixing device 30 is a venturi valve.

In additional or alternative embodiments, the mixing device 30 is coupled to the interior portion 72 and may be replaced with another mixing device that is different in size from the previous mixing device. The mixing device 30 may be coupled to the interior portion 72 using one or more screws. Some benefits of replacing the size of the mixing device 30 may include controlling the flow of liquid and gas and changing the ratio of liquid and gas being mixed within the mixing device 30.

According to some embodiments, a user can control the amount of gas and/or liquid that enters the mixing device 30. Some benefits of controlling the amount of gas and/or liquid that enters the mixing device 30 may include restricting the flow of mixture that is dispensed from the water oxidation system and ensuring the correct amount of gas is being mixed with the liquid.

As shown in FIG. 2A, the mixing device 30 is fluidly coupled with a sensor housing 262. The sensor housing 262 may house a sensor that measures the mixture within the system 10 and is coupled to a probe 264 that extends away from the sensor housing 262. In some embodiments, the sensor is an oxidation-reduction potential (ORP) sensor that measures the net voltage potential of excess oxidizers or reducers present in a mixture. According to some embodiments, the probe 264 includes a clap that couples the probe 264 to an object, wherein the probe 264 is able to measure a mixture without impeding the flow of the mixture within the system 10. In additional or alternative embodiments, the probe 264 includes a glass tip. The probe 264 and sensor may also be electrically coupled with the electrical system 80. In additional or alternative embodiments, the probe 264 and sensor are coupled to the electrical system 80 with a wire.

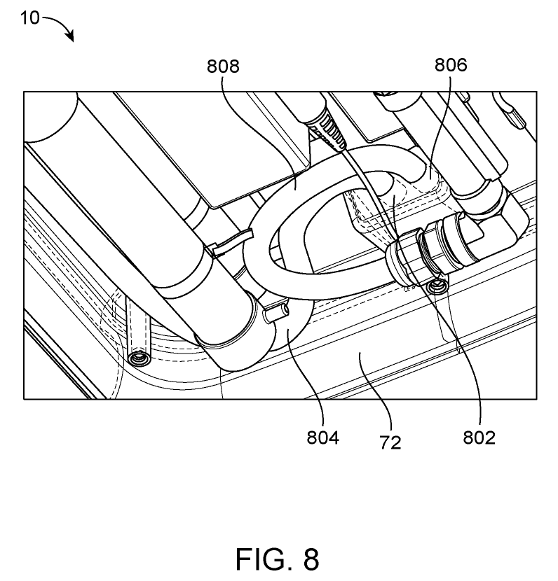

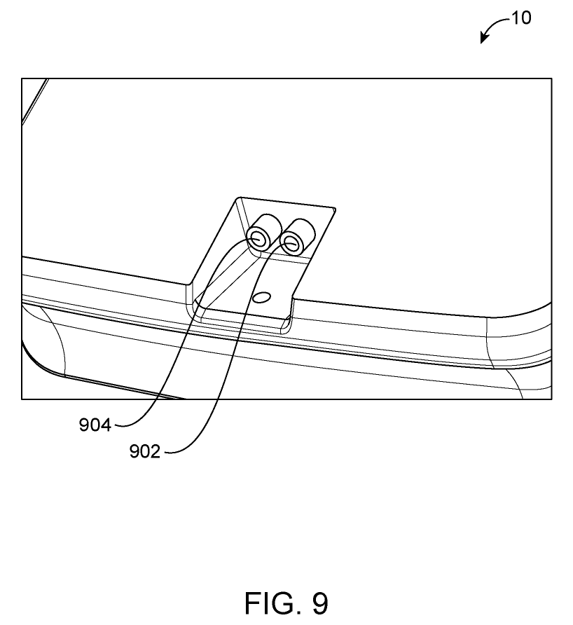

Also shown in FIG. 2A is a control device 40 fluidly coupled with the sensor housing 262, an outlet tube 210, and/or an output elbow 206 located at least partially on the exterior of the system 10. The outlet tube 210 may be configured to extend out of the interior portion 72 of the system 10 at an output port (as shown and described in FIGS. 8 and 9 below) and fluidly couple with an external receiver that dispenses the mixture created by the system 10. In some embodiments, the outlet tube 210 is configured to reduce the distance the mixture needs to travel from the outlet tube 210 to an output elbow 206 and/or the external receiver. Some benefits of configuring distance between the control device 40 to the outlet tube 210 and/or the output elbow 206 may include that after the flow of the mixture is halted, there may be minimal mixture left in the system 10.

In some embodiments, the control device 40 is a Y-pipe and valve. In additional or alternative embodiments, the output elbow 206 is fluidly coupled to a nozzle 208 located at least partially on the exterior of the system 10.

FIG. 2B illustrates a perspective view of the system 10, according to some embodiments. Specifically, FIG. 2B depicts the flow of a fluid through the system 10 and described with respect to the components as detailed in FIG. 2A. In some embodiments, the fluid inlet tube 202 intakes water from a public source, and the fluid flows to a flow switch 204. The fluid then proceeds from the flow switch 204 to a mixing device 30, where the water is mixed with a gas to create a mixture. The mixture then proceeds to the sensor housing 262 and is sent to the control device 40 and the probe 264 for measurement. The mixture in the control device 40 may then proceed to the outlet tube 210, which is fluidly coupled to the output elbow 206 and/or an external receiver.

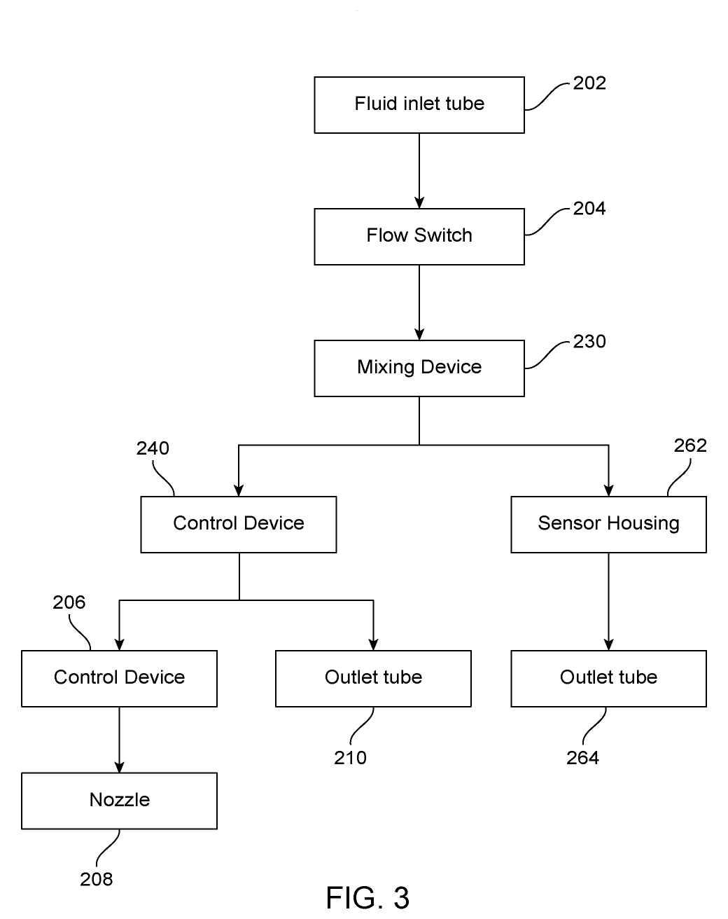

FIG. 3 illustrates a block diagram of the water oxidation system depicting the flow of a liquid, according to some embodiments. As shown in FIG. 3, a fluid inlet tube 202 is fluidly coupled to an external water source, where water flows from the external water source into the fluid inlet tube 202. The water then flows from the fluid inlet tube 202 to a flow switch 204, and the flow switch 204 then activates the system 10. Water then flows from the flow switch 204 into the mixing device 30, where the water is mixed with ozone to form a water-ozone mixture, herein referred to as “mixture.” The mixture then goes from the mixing device 30 into a sensor housing 262 and a control device 40. The sensor housing 262 contains a sensor with a probe 264 that measures an ORP of the mixture. In the control device 40, the mixture then has two flow paths that are determined by a user. In the first path, the mixture flows from the control device 40 into an outlet tube 210, where the outlet tube 210 may then exit system 10 and connect to an external receiving device, such as a washing machine. In the second path, the mixture flows from the control device 40 into an output elbow 206. The output elbow 206 may be fluidly coupled to a nozzle 208, where the mixture may dispense from the nozzle 208.

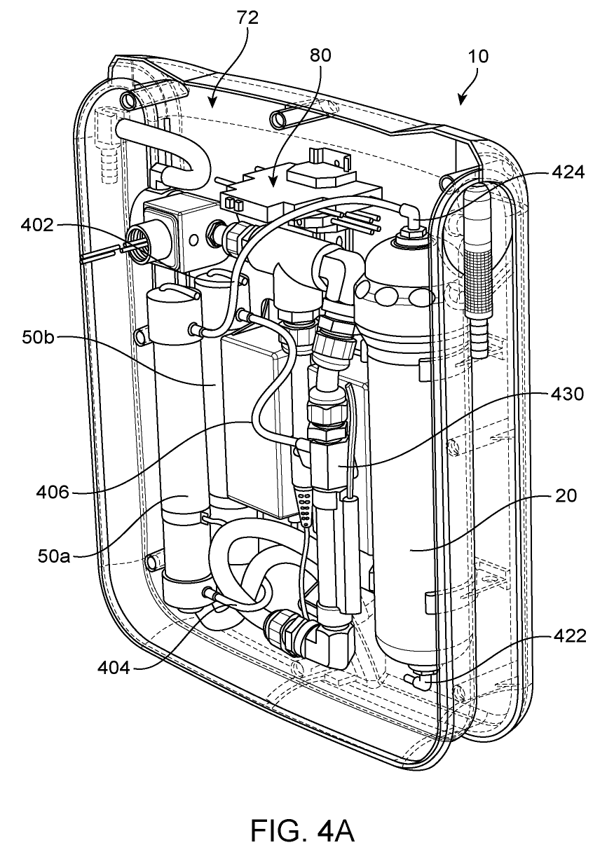

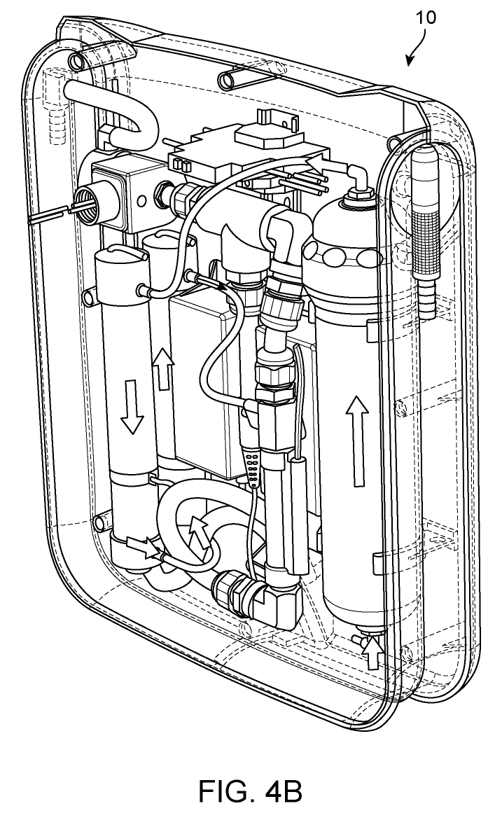

FIG. 4A illustrates a perspective view of a water oxidation system, according to some embodiments. Specifically, FIG. 4A depicts an air system located at least partially within the interior portion 72. As shown in FIG. 4A, the air system may include a container 20 with a container inlet 422 located on one end of the container 20 and a container outlet 424 located on an end opposite of the container inlet 422. The container 20 may be configured to receive a gas at the container inlet 422 and output the gas at the container outlet 424.

In some embodiments, the container 20 is configured to regulate the moisture level of the gas. The container 20 may regulate the moisture level of the gas by removing moisture from the gas by dehumidifying the gas. According to some embodiments, the container 20 is filled with a material that is able to absorb moisture. In additional or alternative embodiments, the container 20 is filled with a desiccant, such as a plurality of desiccant beads. The container 20 may dehumidify, or substantially dehumidify, and remove, or substantially remove, moisture from the gas.

In additional or alternative embodiments, the container 20 is also mechanically coupled to the interior portion 72. Some benefits of coupling the container 20 to the interior portion 72 may include facilitating the servicing of the container 20 by a user, as well as facilitating the removal of the container 20. In some embodiments, the container 20 is coupled to the interior portion 72 with a dock configured to couple with the container 20. In additional or alternative embodiments, the interior portion 72 includes a tube configured to couple with the container 20 to secure the container 20.

As shown in the embodiment of FIG. 4A, the air system of the water oxidation system may include a first generator 50a that is fluidly coupled to a container outlet 424 with a first gas tube 402 and configured to receive a gas. A second generator 50b may be fluidly coupled to the first generator 50a at the bottom with a second gas tube 404. In some embodiments, both generators are configured to generate an internal electrical current or pulse, thereby exciting a gas that is present within the generators. The first generator 50a and second generator 50b may be configured to include one or more outlets and one or more inlets configured to fluidly couple the generators to the gas tubes. In some embodiments, the first generator 50a and second generator 50b are arranged in a pathway that is similar to a series circuit.

In additional or alternative embodiments, air is excited in the first generator 50a to create ozone, and the ozone, along with any air remaining within the first generator 50a, is then further excited in the second generator 50b to excite any of the remaining air to ozone. In some embodiments, the second generator 50b is fluidly coupled to a mixing device 30 with a third gas tube 406. The second generator 50b may be configured to provide ozone to the mixing device 30. In some embodiments, the mixing device 30 is a venturi. In additional or alternative embodiments, the generator 50 is configured to be a chlorine generator. The system 10 may include a chlorine generator configured to fluidly couple with the mixing device 30.

The first generator 50a and the second generator 50a may be configured to switch between an off state where no electrical current or pulse is being generated and an on state where an electrical current or pulse is being generated. In some embodiments, the first generator 50a and the second generator 50b can switch between the on and off state by an electrical system 80 electrically coupled with the first generator 50a and the second generator 50b.

In additional or alternative embodiments, the first generator 50a and second generator 50b are configured to be replaced with another generator of a different size. Some benefits of replacing the generators with a different size may include greater or lesser area for the gas to flow through the generators, resulting in more or less excited gasses, respectively.

FIG. 4B illustrates a perspective view of the water oxidation system depicting the flow of a gas through the water oxidation system, according to some embodiments. In some embodiments, a gas enters the system 10 at a container inlet 422 fluidly coupled to a container 20, where the gas flows through the container 20 into a container outlet 424 that is fluidly coupled to the container 20. The container outlet 424 may be fluidly coupled to a first generator 50a and may flow through the first generator 50a into a second generator 50b fluidly coupled to the first generator 50a. The gas may then flow through the second generator 50b to a mixing device 30 fluidly coupled to the second generator 50b.

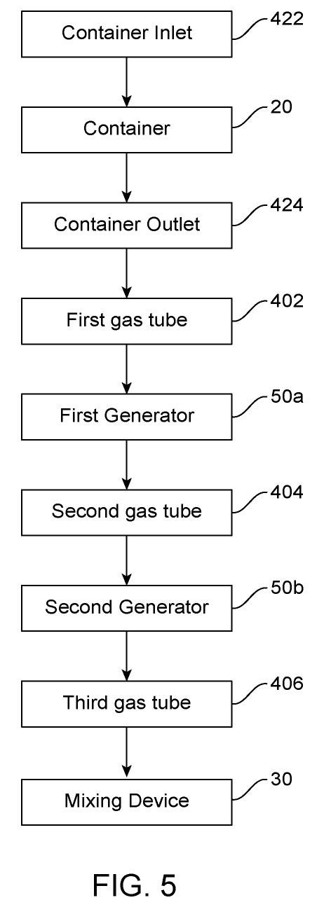

FIG. 5 illustrates a block diagram of the water oxidation system depicting the flow of a gas, according to some embodiments. As shown in FIG. 5, a container inlet 422 is configured to receive an external gas, herein described as air. The air may enter the container inlet 422 and flow into a container 20. The container 20 may be configured to dehumidify the air as it passes through. The air may pass through the container 20 to the container outlet 424 fluidly coupled to a first gas tube 402. The air may flow from the first gas tube 402 into a first generator 50a, where the first gas tube 402 couples with the first generator 50a located near the top of the first generator 50a. The gas may then flow through the first generator 50a and exit into a second gas tube 404, which fluidly couples the first generator 50a to a second generator 50b at the bottom of the first generator 50a and second generator 50b. The first generator 50a and second generator 50b may be configured to excite the air by emitting an electrical current or charge through the air to excite the O2 molecules and form ozone (O3). The air, by passing through the first generator 50a, may result in a gaseous mixture that includes both air and ozone, indicating that some of the air has not been converted into ozone. By passing through the second generator 50b, any remaining O2 molecules may become excited and converted to O3, resulting in complete, or almost complete conversion of air to ozone. The air, now completely, or almost completely excited and converted into ozone, may flow through the second generator 50b and enter a third gas tube 406, which is fluidly coupled to the second generator 50b and a mixing device 30, and may enter the mixing device 30 to be mixed with a liquid.

FIG. 6 illustrates another block diagram of the water oxidation system depicting the flow of both a liquid and a gas, according to some embodiments. As shown in FIG. 6, upon activation of the system 10, water from an external liquid source enters a water inlet tube. Concurrently, air may enter a container inlet and flow into a container where the air may be dehumidified and moisture may be removed. The dehumidified air may then flow out of the container and into a container outlet, where the air flows through a first gas tube into a first generator.

The water, upon entering the flow switch, may trigger an electrical system. The electrical system may be configured to send power to the first generator and a second generator upon water entering the flow switch. In some embodiments, the first generator and the second generator are configured to emit an electrical signal to excite the air (O2) molecules to form ozone (O3). Upon the electrical system powering the first generator and the second generator, the air may flow through the first generator while being excited to form ozone. The ozone and any remaining air may then flow from the first generator to the second generator through a second gas tube. The second gas generator may be configured to convert any remaining O2 molecules from the first generator into ozone. The ozone in the second generator may flow through a third gas tube and into a mixing device.

The mixing device may be configured to mix the water and the ozone to make a mixture. In some embodiments, a user is able to configure mixture ratios of water to ozone by replacing the mixing device with a mixing device that varies in size according to the user’s need. In additional or alternative embodiments, as soon as the water enters the flow switch, ozone is immediately infused with the water at the mixing device to create the mixture. The mixture may then flow into a sensor housing and a control device concurrently.

The sensor housing may be configured to house a sensor and a probe. The water, as it enters the sensor housing, may be measured by a probe that may be configured to measure the ORP of the mixture without affecting the flow of the mixture through the system. In some embodiments, the probe is communicatively coupled to an electrical device that may be configured to display the probe’s measurements.

Concurrently, the mixture may flow through the control device that may be configured by the user to output the mixture to an output elbow or an outlet tube. In some embodiments, the control device includes an actuator (such as a button) that the user holds to dispense the mixture, and when the user releases the actuator, results in a stopping of the dispensing of the mixture. In additional or alternative embodiments, the mixture flows from the control device to the outlet tube, which is configured to exit the water oxidation system and couple with a laundry washing machine.

According to some embodiments, the mixture flows from the control device into the output elbow. In additional or alternative embodiments, the mixture flows from the control device into the output elbow fluidly coupled with a nozzle and dispensed from the nozzle. In some embodiments, the output elbow is fluidly coupled to the nozzle with a hose or a tube.

In additional or alternative embodiments, the pipe and tubing within the water oxidation system are configured to minimize sharp angles and have smooth curves. Some benefits of minimizing sharp angles may include minimal water, gas, mixture, or combinations thereof left within the water oxidation system after being deactivated.

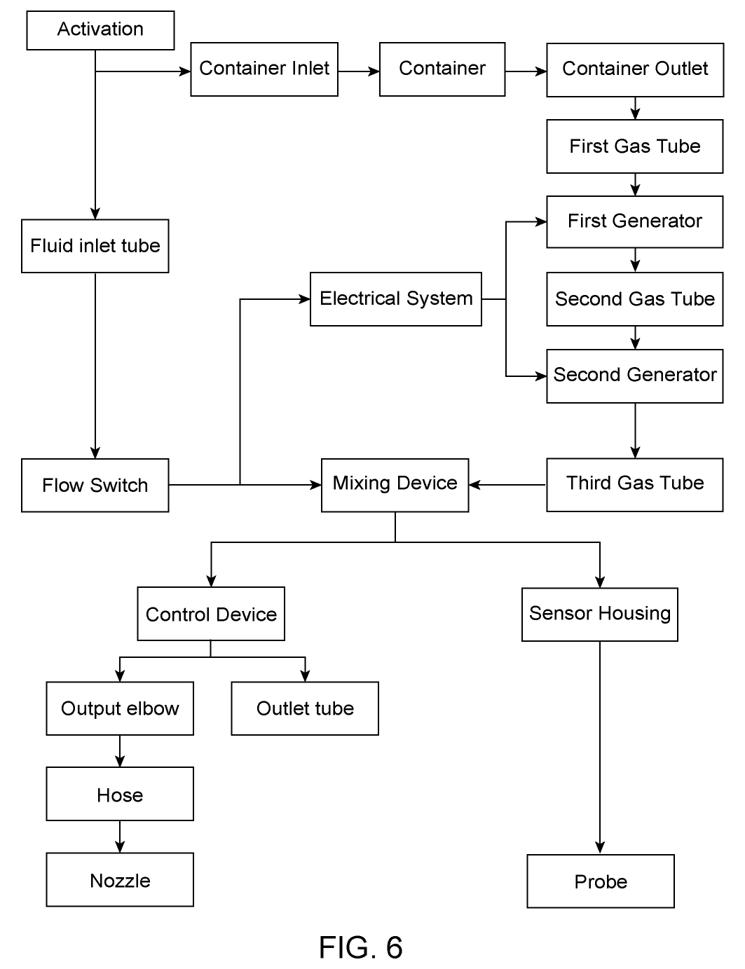

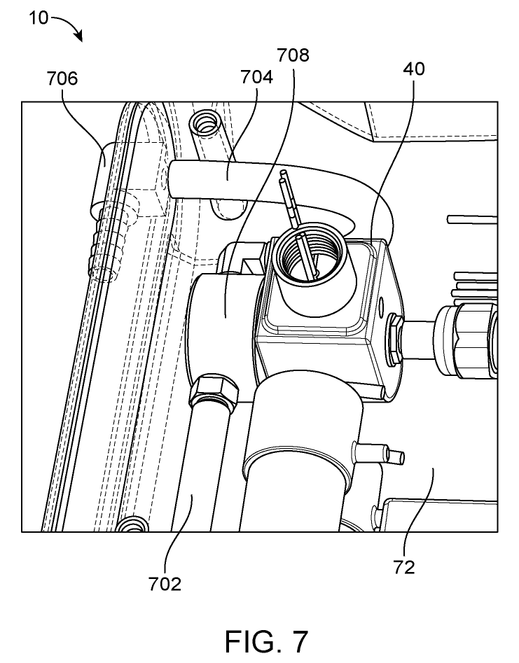

FIG. 7 illustrates a bottom perspective view of a control device of a water oxidation system, according to some embodiments. As illustrated in FIG. 7, a control device 40 is configured to fluidly couple with a control valve 708. In some embodiments, the control valve 708 is fluidly coupled to an output tube 702 and/or an elbow tube 704 and is configured to dispense to one of the tubes. In additional or alternative embodiments, the elbow tube 704 is fluidly coupled to an output elbow 706 and is configured to reduce the distance the mixture travels from the control device 40 to the output elbow 706. The control device 40 may fluidly couple with a non-valved nozzle. In additional or alternative embodiments, the control device 40 is a Y valve and a separate valve. In some embodiments, the control device 40 is an all-in-one Y and valve combination. The control device 40 may also be a one-way or two-way valve.

According to some embodiments, the control device 40 is configured to adjust the rate at which the mixture may be dispensed from the system 10 at the output elbow 708 and/or the output tube 702. In additional or alternative embodiments, the control device 40 is configured to have an actuator (such as a push button) that controls the rate at which the mixture is dispensed at the output elbow 708 and/or output tube 702.

FIG. 8 depicts a top partial perspective view of a water oxidation system, according to some embodiments. As shown in FIG. 8, an output port 802 is configured to receive an output tube 804. In some embodiments, the output tube 804 extends from an interior portion 72 of the system 10 and fluidly couple with an external device such as a washing machine. In additional or alternative embodiments, the output tube 804 extends from the interior portion 72 of the system 10 and dispenses the mixture into an external container.

Also shown in FIG. 8 is an input port 806 that is configured to receive a fluid inlet tube 808. In some embodiments, the fluid inlet tube 808 fluidly couples with a washing machine water source. In additional or alternative embodiments, the water inlet tube 808 fluidly couples with a city cold water source.

FIG. 9 illustrates a partial bottom perspective view of a water oxidation system, according to some embodiments. As shown in FIG. 9, an input port 904 may be configured to receive an external water source. In additional or alternative embodiments, the input port 904 is configured to fluidly couple with an external source. FIG. 9 also depicts an output port 902 that may be configured to fluidly couple with an external device. In some embodiments, the output port 902 is configured to fluidly couple with a washing machine. In additional or alternative embodiments, the output port 902 is configured to have one or more output ports. Some benefits of one or more output ports may include more pathways for a liquid to be dispensed from the water oxidation system.

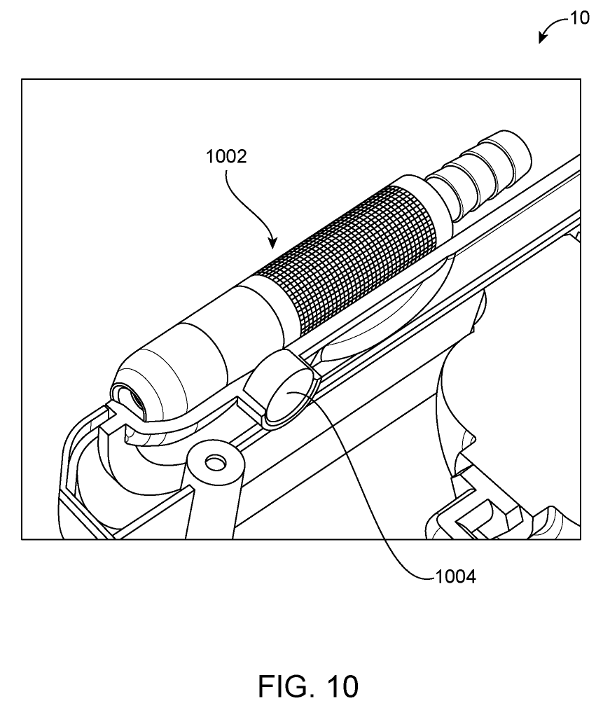

FIG. 10 illustrates a partial top perspective view of a water oxidation system, according to some embodiments. As shown in FIG. 10, a nozzle 1002 is coupled to the exterior of the system 10. In some embodiments, the system 10 includes a magnet 1004. The nozzle 1002 may be magnetically coupled to the system 10 with the magnet 1004. In additional or alternative embodiments, a portion of the nozzle 1002 is knurled. Some benefits of a portion of the nozzle 1004 being knurled may include better grip for a user holding the nozzle 1004.

In additional or alternative embodiments, the nozzle 1004 is configured to fluidly couple with an output elbow (as shown and described in FIG. 2A above). In some embodiments, the nozzle 1004 couples with the output elbow with a hose. In additional or alternative embodiments, the nozzle 1004 fluidly couples with the output elbow with a tube. According to some embodiments, the hose or tube is fluidly coupled to the nozzle 1004 and configured to wrap under the device and fluidly couple with the output elbow (as shown and described in FIG. 2A above).

In some embodiments, the nozzle 1004 is configured to include a housing configured to house a filtration material. In some embodiments, the filtration material is coal.

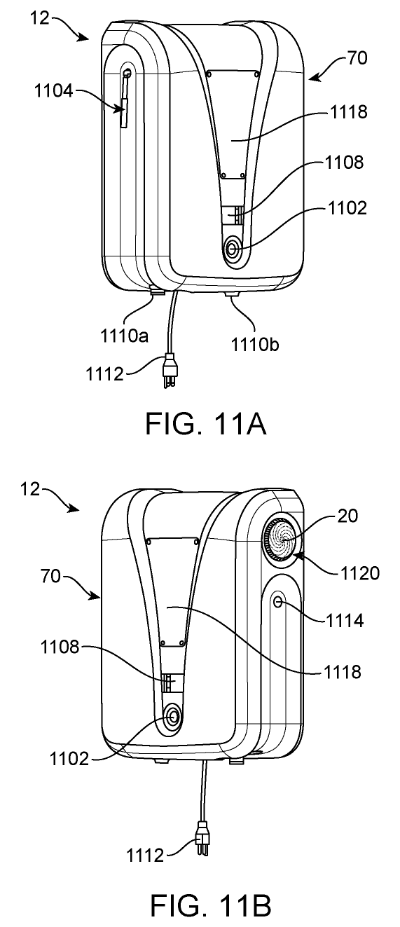

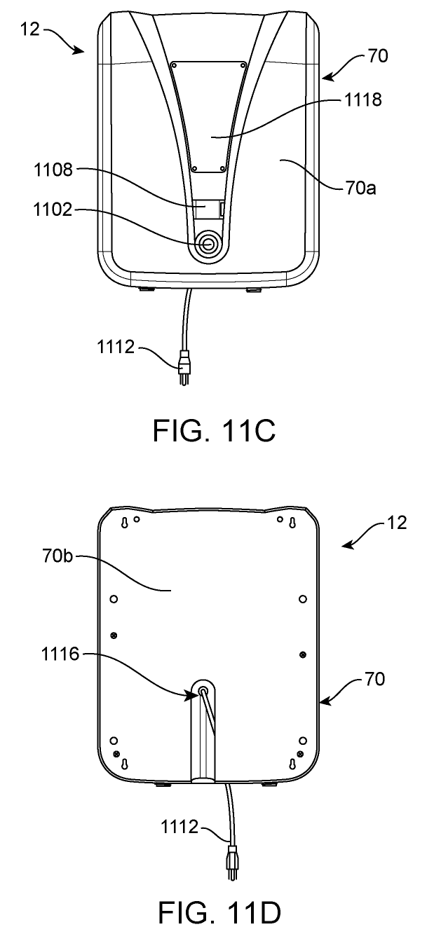

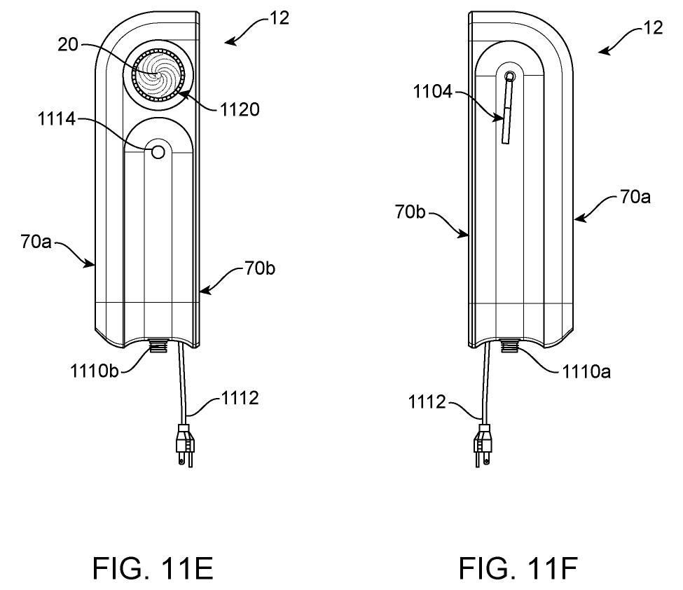

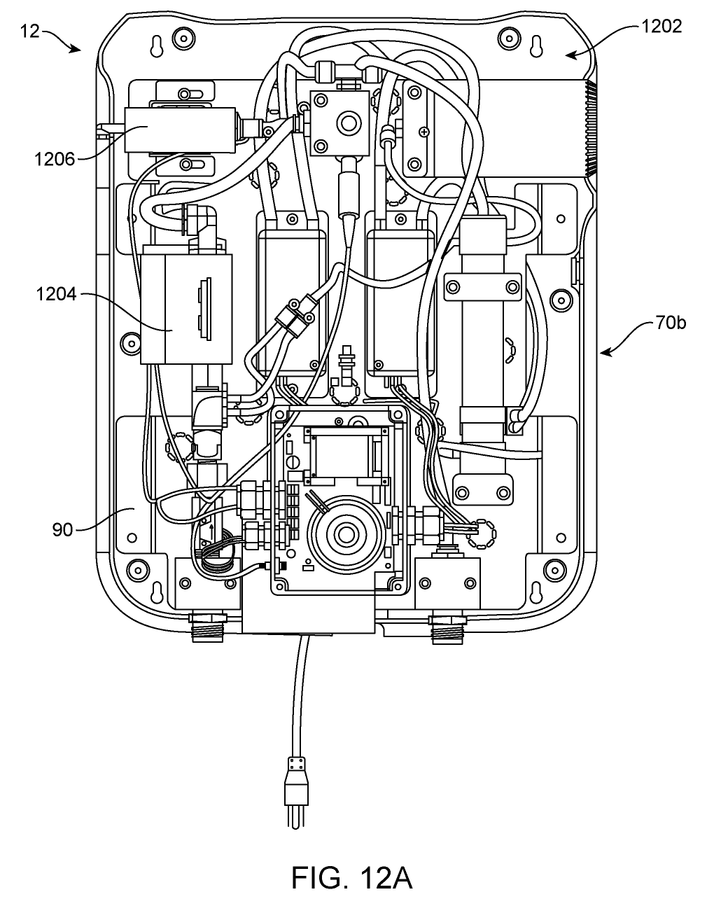

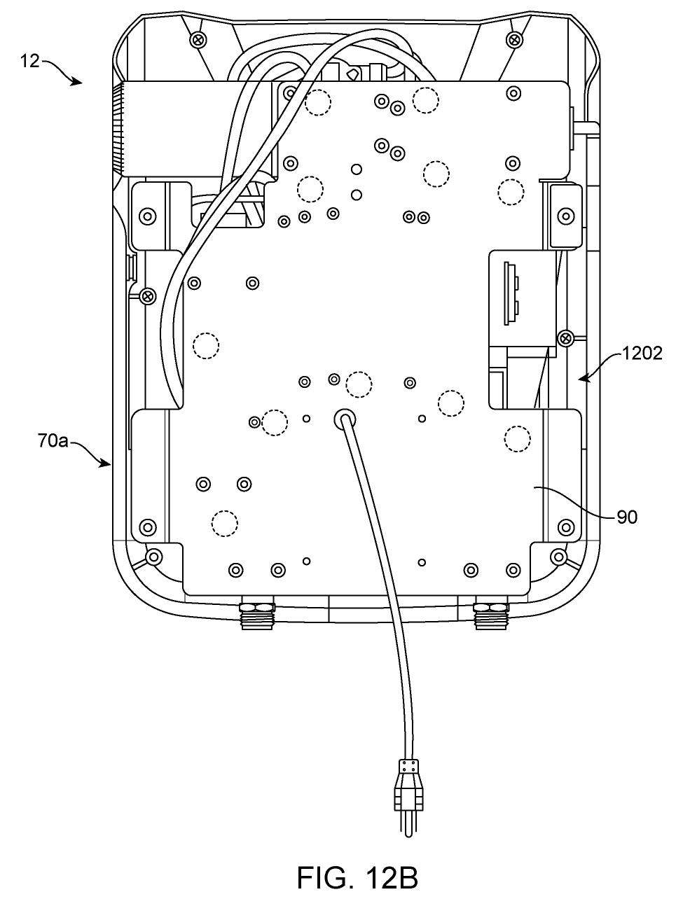

FIG. 11A illustrates a perspective view of another water oxidation system 12, according to some embodiments, and FIGS. 11B, 11C, 11D, 11E, and 11 illustrate an additional perspective, front, rear, side, and an additional side view, respectively, thereof. In the embodiment as shown in FIG. 11A, the system 12 may include a housing 70 configured to cover all of, or at least a substantial portion of the system 12. The housing 70 may include a front cover 70a and a rear cover 70b configured to couple to the front cover 70a. In some embodiments, when the front cover 70a and the rear cover 70b are coupled to each other, the system 12 defines an interior portion (as shown and described below in FIGS. 12A and 12B), that is an interior compartment of the housing 70 in which different components and necessary electronics are stored. The front cover 70a and the rear cover 70b, when decoupled from one another, may permit a user to access the different components and necessary electronics within the interior portion of system 12. In some embodiments, the housing 70 is sized and configured to facilitate easy access for a user to service any internal component of system 12. The front cover 70a, the rear cover 70b, or both, may be configured to securely couple with any internal component or necessary electronics of system 12.

In additional or alternative embodiments, the system 12 may include an access panel 1118 located at least partially on the housing 70. In some embodiments, the access panel 1118 is located at least partially on the front cover 70a and coupled to the front cover 70a. The access panel 1118 may be located near one or more internal components (e.g., the container, the sensor, etc., as described herein), and may be configured to permit a user access to at least a portion of one or more internal components without the need to decouple the front cover 70a from the rear cover 70b.

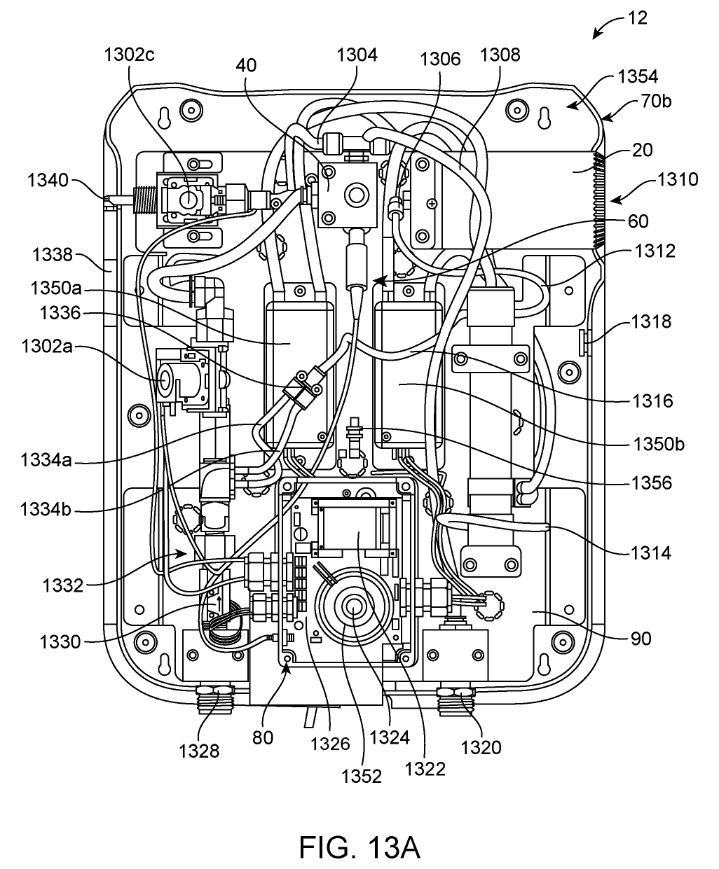

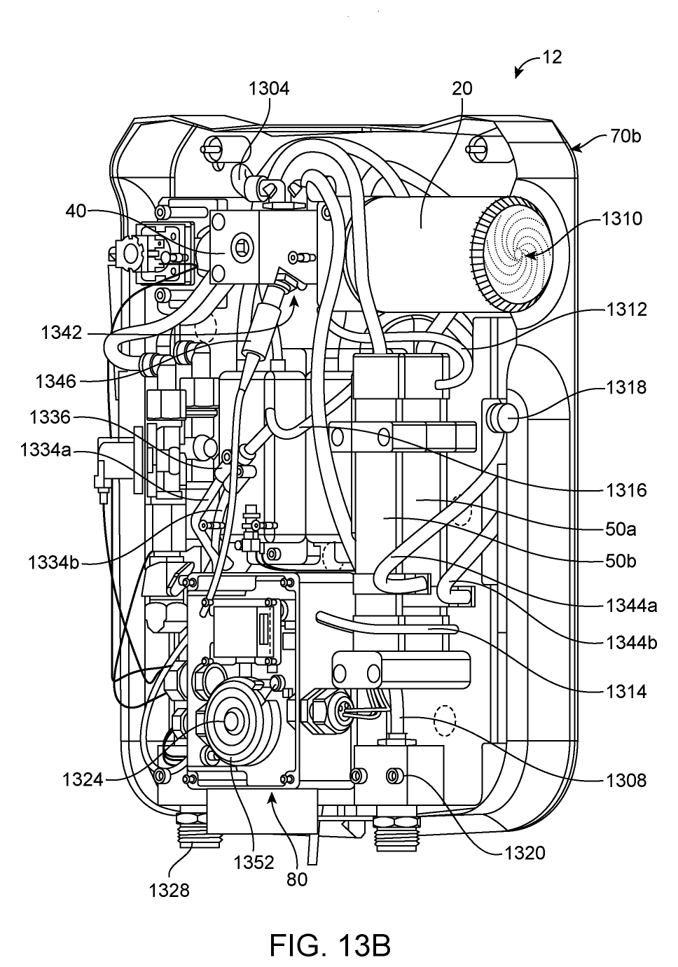

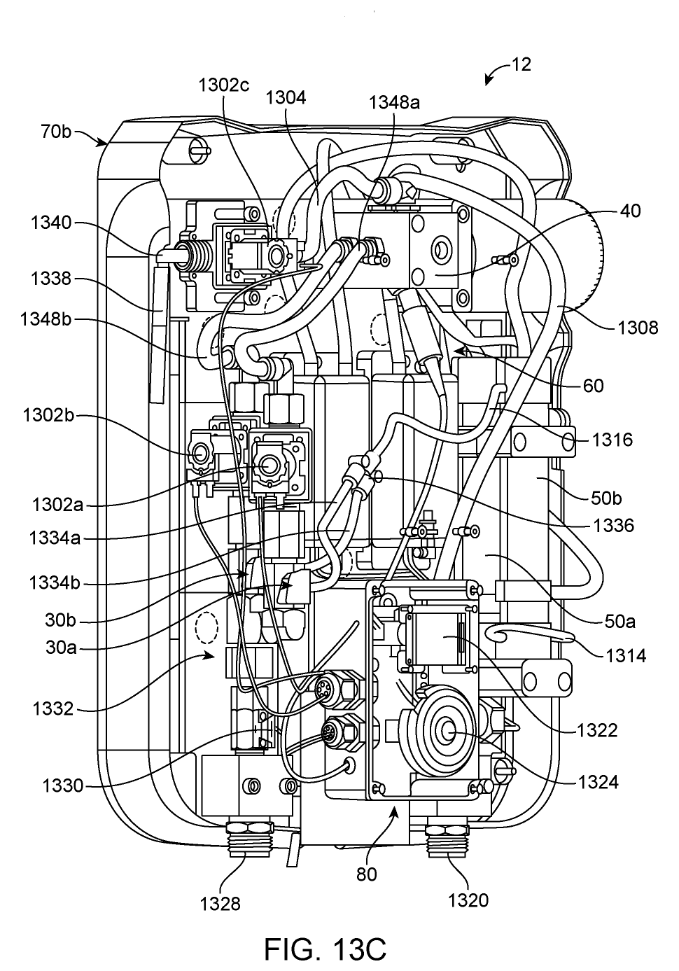

The access panel 1118 may be located near a sensor (as shown and described below in FIGS. 13A-C). In additional or alternative embodiments, the access panel 1118 may be sized and configured such that the user is able to access the sensor, the container, or both. For example, the access panel 1118 may be configured to provide a user easy access to the sensor and may permit the user to perform maintenance through the access panel 1118.

The front cover 70a and the rear cover 70b may be coupled by a plurality of fasteners. In some embodiments, the front cover 70a and the rear cover 70b are configured to slidably couple. The front cover 70a may be configured to hingedly couple with the rear cover 70b. In additional or alternative embodiments, the front cover 70a and the rear cover 70b are configured to magnetically couple.

In additional or alternative embodiments, the front cover 70a and the rear cover 70b include a plurality of male coupling mechanisms and a plurality of female coupling mechanisms. In some embodiments, the number of male coupling mechanisms is greater than the number of female coupling mechanisms. The number of female coupling mechanisms may be greater than the number of male coupling mechanisms. In some embodiments, it is desirable to align the number and position of male coupling mechanisms with the number and positioning of the associated female coupling mechanisms.

The male coupling mechanisms may be configured to at least partially insert into the female coupling mechanism. The female coupling mechanisms may be configured to at least partially receive the male coupling mechanisms. In additional or alternative embodiments, the male coupling mechanisms may be configured to interact with the female coupling mechanisms when the male coupling mechanism is at least partially inserted into the female coupling mechanism, such that the male coupling mechanisms and female coupling mechanisms form at least and maintain at least a partial coupling.

In some embodiments, the system 12 includes a display 1108 located at least partially on the housing 70. The display 1108 may be a liquid crystal display (LCD), a light emitting diode (LED) display, a quantum dot LED (QLED) display, an electronic paper display, a microLED display, an in-plane switch (IPS) display, a vertical alignment (VA) display, a twisted nematic (TN) display, an organic light emitting diode (OLED) display, or a cathode ray tube (CRT) display. The system 12 may include an actuator 1102 located at least partially on the housing 70. In some embodiments, the display 1108 is configured to receive an input from the system 12 and configured to display the input. The display 1108 may be configured to receive the input from an electrical system (as shown and described below in FIGS. 13A-13C). The display 1108 may be configured to display an ORP value, (as described herein) a liquid flow rate, a mixture flow rate, or combinations thereof. In additional or alternative embodiments, the system 12 includes a display 1108 and an actuator 1102 located at least partially on the front cover 70a. The actuator 1102 may be a button, a switch, or a toggle. In some embodiments, the actuator 1102 is a push button. The actuator 1102 may be configured to set the system 12 into a second flow path configuration.

In additional or alternative embodiments, the system 12 includes a rear cover port 1116 located at least partially on the housing 70. In some embodiments, the rear cover port 1116 is located on the rear cover 70b. The rear cover port 1116 may be sized and configured to receive an external connection. The system 12 may include a power cord 1112 configured to couple with an electrical power source (e.g., a power outlet). The power cord 1112 may be coupled with the electrical system of the water oxidation system (as shown and described below in FIGS. 13A-C) to deliver electrical power thereto, and thereby provide power to any internal component of system 12. In some embodiments, the rear cover port 1116 is sized and configured to receive the power cord 1112.

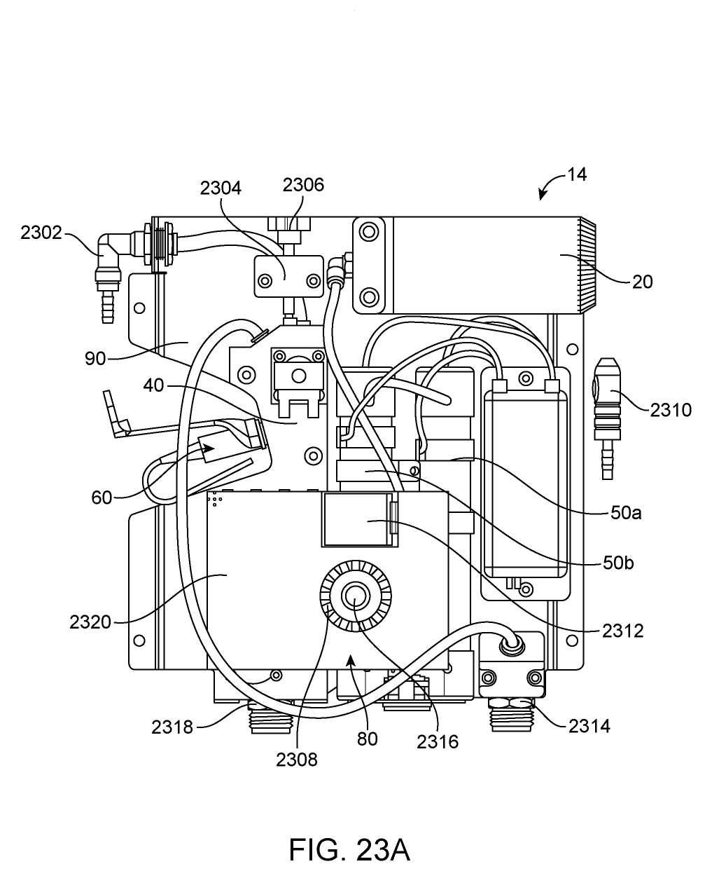

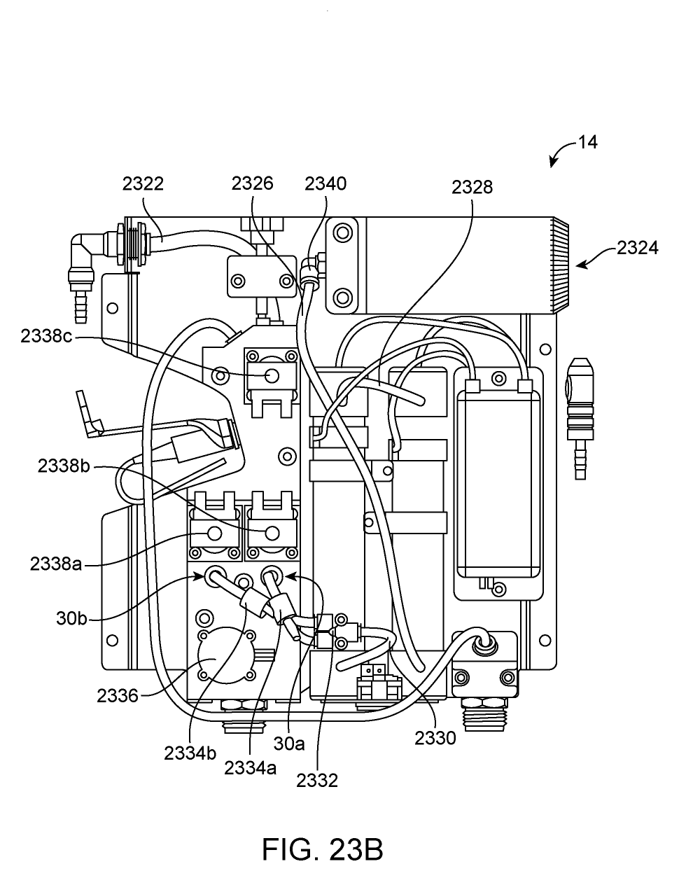

The system 12 may include a fill system 1104 located on the housing 70 (see for example FIG. 11F) and coupled to the housing 70. In some embodiments, the fill system 1104 is located between the front cover 70a and rear cover 70b when the front cover 70a and rear cover 70b are coupled together. In additional or alternative embodiments, the fill system 1104 includes an output elbow (as shown and described below in FIGS. 13A-C), a nozzle (similar to as shown and described above in FIGS. 2A and 10 and below in FIGS. 23A & 23B), or both. The fill system 1104 may be a bottle fill system. The fill system 1104 may be a fill station. In some embodiments, the fill system 1104 is a bottle fill hose system. The fill system 1104 may include a hose, a hose attachment, or both. The fill system 1104 may be configured to dispense a fluid (which may, for example, include a mixture) from the system 12 to an external component, an external surrounding, or both. In some embodiments, the fill system 1104 is configured to dispense the fluid from system 12 to a bottle, a mop, or a bucket. The fill system 1104 may be configured to dispense the mixture from system 12 into an external component sized and configured to receive a fluid (i.e., a liquid).

The system 12 may include a magnet 1114 located on the housing 70 and coupled to the housing 70. In some embodiments, the front cover 70a and rear cover 70b are sized and configured to receive the magnet 1114 such that when the front cover 70a and rear cover 70b are coupled, the front cover 70a and rear cover 70b surround the magnet 1114. The magnet 1114 may be configured to magnetically couple with a nozzle (similar to as shown and described above in FIGS. 2A and 10, and below in FIGS. 23A and 23B). In some embodiments, the magnet 1114 is a magnetic catch. In additional or alternative embodiments, the magnet 1114 is configured to securely couple a nozzle, a nozzle tube, or both, to the housing 70. The nozzle may be configured to couple with a nozzle tube.

In some embodiments, system 12 includes a container 20 located at least partially within the housing 70. The container may be similar in function as container 20 in FIG. 1 (e.g., configured to dry or dehydrate a gas, such as air), but may have a different form, shape, and/or orientation within the water oxidation system 12. The housing 70 may define a container port 1120 sized and configured to receive a container 20. The front cover 70a and the rear cover 70b may be sized and configured such that when coupled together, the front cover 70a and rear cover 70b define the container port 1120. Benefits of the container port 1120 may include permitting a user to easily insert and/or remove the container 20 for replacement, service, and/or maintenance without the need to decouple the front cover 70a from the rear cover 70b to access the container 20.

The system 12 may include an input port 1110a and an output port 1110b located at least partially within the housing 70. In some embodiments, the input port 1110a and the output port 1110b are located at the bottom of the housing 70. The system 12 may be configure to receive a fluid (i.e., a liquid) from an external fluid source. The input port 1110a may be configured to couple with an external fluid source (i.e., a liquid source). In some embodiments, the system 12 receives fluid from the external fluid source via a fluid inlet tube (as shown and describe above in FIG. 8 and below in FIGS. 13A-C). The output port 1110b may be an outlet port.

In additional or alternative embodiments, the output port 1110b is sized and configured to couple to an external connection. The output port 1110b may be fluidly coupled with the external connection such that a fluid or a mixture within the system 12 flows to the external connection. In some embodiments, the external connection is a sink. The external connection may be a laundry machine (i.e., a washing machine), a dishwasher, or other external connections configured to receive a liquid or a mixture. The system 12 may be configured such that a fluid or a mixture may be able to flow through the entire system 12 when the system 12 is off, such as in a powered down state (e.g., not activated).

The system 12 may be sized and configured to be installed and/or mounted under an object, surface, roof, or combinations thereof. The system 12 may be sized and configured to be used under an object, surface, roof, or combinations thereof. The system 12 may be sized and configured to be installed and/or mounted under a sink. In additional or alternative embodiments, the system 12 is sized and configured to be used under a sink. The system 12 may be sized and configured to be installed and/or mounted in a garage. The system 12 may be sized and configured to be used in a garage. In additional or alternative embodiments, the system 12 is sized and/or configured to mount and/or be used with a vehicle (e.g., a recreational vehicle [“RV”], car, truck, etc.). In some embodiments, the system 12 is sized and/or configured to be used for automotive purposes. The system 12 may be sized and/or configured to mount with and/or be used with food service equipment (e.g., an ice cream machine), and/or other similar services or machines (e.g., ice machine, water dispenser, frozen treats, etc.). In some embodiments, the system 12 is sized and/or configured to be used for general cleaning. The system 12 may be sized and/or configured to be used with cleaning devices (e.g., countertop cleaning devices, and/or for cleaning or washing countertops). In other embodiments, the system 12 is sized and/or configured to be used in small commercial settings such as (a bar, a kitchen, an automotive detailer).

In some embodiments, the system 12 is sized and configured to be used with a laundry unit. The system 12 may be sized and configured to be used with a washing unit, a dishwashing unit, a sink unit, an ice machine, a hose outlet for cleaning, and/or the like. In additional or alternative embodiments, the system 12 is an under-the-sink system. The system 12 may be a laundry unit. In some embodiments, the system 12 is a washing unit. The system 12 may be a garage unit. In additional or alternative embodiments, the system 12 is an air unit. Benefits of system 12 being able to be sized and configure to be installed, mounted, used, or combinations thereof may include a system 12 unit that serves different external components that require different amounts of fluid or mixture, or may include facilitating the system 12 to be located and used in an external environment that suits the external components needs. In some cases, the system 12 is configured to deliver fluid to multiple different external connections, simultaneously and/or individually.

FIG. 12A illustrates a front view of a water oxidation system 12, without the front cover 70a, according to some embodiments, and FIG. 12B illustrates a rear view thereof, without the rear cover 70b. In the embodiment as shown in FIG. 12A, the system 12 may include an interior portion 1202 defined within a housing (as shown and described above in FIGS. 11A-F) of system 12. In some embodiments, the front cover 70a and the rear cover 70b of the housing 70 are configured such that when the front cover 70a and rear cover 70b are coupled together, the front cover 70a and the rear cover 70b define the interior portion 1202 therewithin (and/or therebetween).

The system 12 may include a frame 90 (e.g., see FIG. 13A) located at least substantially within the interior portion 1202. In additional or alternative embodiments, the frame 90 is coupled to the front cover 70a, the rear cover 70b, or both. In some embodiments, the frame 90 is sized and configured to permit any internal component or necessary electronics of system 12 to be securely coupled to the frame 90. The frame 90 may permit any internal component or necessary electronics of system 12 to mount to the frame 90. The frame 90 may be a base, plate, panel, back panel, sheet metal frame, and/or any similar structure, configured to provide a support for the internal components of the system 12. The system 12 may also or alternatively include a back plate 90 configured to also provide support to at least some of the components of the system 12.

In some embodiments, system 12 includes a first component cover 1204 and a second component cover 1206 located at least partially within the interior portion 1202. The first component cover 1204 and the second component cover 1206 may be sized and configured to surround/encompass a control valve (as shown and described below in FIGS. 13A-C). In additional or alternative embodiments, the first component cover 1204 and second component cover 1206 are coupled to the frame 90.

FIG. 13A illustrates a front view of a water oxidation system 12, without front cover 70a (similar to FIG. 12A), according to some embodiments, and FIGS. 13B and 13C illustrate a perspective and an additional perspective view thereof. In the embodiment as shown in FIG. 13A, the system 12 may include a frame 90 configured to couple with a rear cover 70b of a housing (as shown and described above in FIGS. 11A-F), and an interior portion 1354 (which may be interchangeably referred with reference character 1202). A magnet 1318 (as described herein) may be located at least partially on the housing, the front cover 70a, the rear cover 70b, or combinations thereof. In some embodiments, the frame 90 is sized and configured to securely couple any internal component of system 12, such that the internal component is at least partially within the interior portion 1354. System 12 may include a container 20 located at least partially within the interior portion 1354, at least one mixing device (e.g., 30a, 30b, in FIG. 13C), at least one generator (e.g., 50a, 5b, in FIG. 13B), at least one control device 40, at least one sensor 60, and an electrical system 80. In some embodiments, the control device 40 is formed through injection molding. The control device 40 may be formed by machining blocks. In additional or alternative embodiments, the control device 40 is a manifold distribution block.

The container 20 may be located at least partially within the interior portion 1354 and coupled to the frame 90. In some embodiments, the container 20 includes a container inlet 1310 and a container outlet 1306 located opposite the container inlet 1310. The container 20 may be sized and configured to receive and contain a hygroscopic substance. The hygroscopic substance may be desiccant, a plurality of desiccant beads, and/or other materials that may be used to retain (e.g., sustain) or induce a liquid, a state of dryness, in its vicinity. In other words, the container may be configured to dry, dehydrate, and/or induce a level of dryness for a fluid that may pass through, such as a gas, which may include air for example. The container 20 may include a pattern. In some embodiments, the pattern is a recurring pattern. The container 20 may be configured such that a user may remove the entire container 20 from the system 12.

The container 20 may include a cap. In some embodiments, the cap is configured to permit a user to remove the container 20 from the system 12. The cap may be configured to couple and decouple with the container 20 and permit the user to access the contents within the container 20. Benefits of a cap configured to couple and decouple with the container 20 may include permitting a user to access the contents within the container 20 and return the contents within the container 20 to its original state. For example, a user may remove desiccant within the container 20 to microwave the desiccant when it is wet or saturated due to humidity and return the desiccant to its dry original state. Additional benefits of the cap may include permitting the user to remove the container 20 and refill the contents within the container 20 or swap the contents within the container 20 and insert the container 20 into the system 12 without decoupling the front cover 70a from the rear cover 70b. The container 20 may be a desiccant container, a canister, or a desiccant canister.

In some embodiments, the sensor 60 includes a sensor probe 1342 (which may be referred to hear as a treated liquid sensor) and a sensor housing 1346 configured to receive the sensor probe 1342. The control device 40 may be sized and configured to at least partially receive the sensor probe 1342. In additional or alternative embodiments, the sensor probe 1342 is configured to obtain a measurement of a fluid (e.g., mixture and/or a liquid) within the control device 40. The sensor probe 1342 may be communicatively coupled, electronically coupled, or both with the electrical system 80. In some embodiments, the sensor probe 1342 is configured to communicate a measurement of the liquid within the control device 40 to the electrical system 80. The measurement may be an oxidative reduction potential (ORP) level measurement. The electrical system 80 may be configure to display the measurement on the display 1322 (which may be interchangeably referred to with reference character 1108). In some embodiments, the sensor 60 includes a sensor manifold configured to receive a fluid (e.g., mixture [treated liquid]). The sensor manifold may be configured to receive a fluid from the probe 1342. In some embodiments, the sensor probe 1342 or at least a portion thereof may extend into a chamber of the control device 40 (as described herein), such that the sensor probe 1342 contacts the liquid (e.g., treated liquid, ozonated liquid), to obtain the measurement thereof.

In the embodiment as shown in FIG. 13B, the system 12 may include a container 20, a first generator 50a, a second generator 50b, a sensor 60 (which may include sensor probe 1342 and/or sensor housing 1346), and/or an electrical system 80. The container 20 may be configured to couple and/or be fluidly coupled to the first generator 50a. In some embodiments, the first generator 50a is configured to couple and/or be fluidly coupled to the second generator 50b. In additional or alternative embodiments, the second generator 50b is configured to couple and/or be fluidly coupled to a mixing device 30 (e.g., 30a, 30b).

The system 12 may include a first gas tube 1312 sized and configured to couple the container 20 to the first generator 50a and may be further configured to facilitate the flow of a gas from the container 20 to the first generator 50a. The first gas tube 1312 may be configured to couple to the container 20 at the container outlet 1306. In additional or alternative embodiments, the first gas tube 1312 is sized and configured to couple to an inlet of the first generator 50a.

In some embodiments, the system 12 includes a second gas tube 1314 sized and configured to couple the first generator 50a to the second generator 50b. The second gas tube 1314 may be configured to facilitate the flow of a gas from the first generator 50a to the second generator 50b. The second gas tube 1314 may be sized and configured to couple to an outlet of the first generator 50a and/or an inlet of the second generator 50b.

In additional or alternative embodiments, the system 12 includes a third gas tube 1316 sized and configured to couple the second generator 50b to a mixing device. The third gas tube 1316 may be sized and configured to couple the second generator 50b to a y-valve 1336. In some embodiments, the third gas tube 1316 is configured to couple to an outlet of the second generator 50b. The system 12 may include a fourth gas tube 1334a sized and configured to couple the y-valve 1336 to a first mixing device 30a. In some embodiments, the system 12 includes a fifth gas tube 1334b sized and configured to couple the y-valve 1336 to a second mixing device 30b.

In the embodiment as shown in FIG. 13C, the system 12 may include an input port 1328 (which may be referred to as a liquid inlet or first inlet), first mixing device 30a, a first valve 1302a (or maybe herein referred to as a first control valve 1302a), a control device 40, a sensor 60, an electrical system 80, an output tube 1308, and/or an output port 1320. In some embodiments, the system 12 includes a fluid inlet system sized 1332 and configured to facilitate the flow of a liquid through system 12. The fluid inlet system 1332 may be coupled to the input port 1328. In some embodiments, the fluid inlet system 1332 is a fluid inlet tube. The fluid inlet system 1332 may include a fluid inlet tube. The fluid inlet system 1332 may be sized and configured to receive a fluid (i.e., a liquid) from an external fluid source.

In additional or alternative embodiments, the system 12 includes a flow sensor 1330 sized and configured to detect the flow of a liquid passing through the system 12. In some embodiments, the flow sensor 1330 is configure to measure the rate of a liquid flowing through the system 12. The flow sensor 1330 may communicate the rate of a liquid flowing through the system 12 with the electrical system 80. The flow sensor 1330 may be coupled with the fluid inlet system 1332, the input port 1328, or both. In some embodiments, the flow sensor 1330 is a flow switch.

The system 12 may include a first mixing device 30a and a second mixing device 30b. In additional or alternative embodiments, the system 12 includes a first control valve 1302a sized and configured to couple with the first mixing device 30a and further configured to facilitate the flow of a liquid through the system 12. The system 12 may include a second valve 1302b (or maybe herein referred to as a second control valve 1302b), sized and configured to couple with the second mixing device 30b and further configured to facilitate the flow of a liquid through the system 12. In some embodiments, the system 12 includes a third valve 1302c (or maybe herein referred to as a third control valve 1302c). The first control valve 1302a, the second control valve 1302b, the third control valve 1302c, or combinations thereof may be configured to permit a liquid to flow through the system 12 and/or prohibit the flow of a liquid through the system 12. The first control valve 1302a, the second control valve 1302b, the third control valve 1302c, or combinations thereof may be a solenoid valve or a mechanical valve.

In some embodiments, any of the control valves include an open state and/or a closed state. When any of the control valves are in the open state, the control valves may be configured such that a liquid may pass through the control valve and flow through the system 12. In additional or alternative embodiments, when any of the control valves are in the closed state, the control valves are configured such that a liquid is prevented from flowing through the control valve and system 12. When any of the control valves are in the open state, the control valves may be configured to permit at least some liquid to flow past. Any of the control valves in the open state may be configured to permit all of a liquid to flow past. In some embodiments, when any of the control valves are in the closed state, the control valves are configured to prohibit liquid from flowing therethrough (i.e., through the respective control valve). In some embodiments, when any of the control valves are in the closed state, the control valves are configured to prohibit at least some liquid from entering and flowing through the system 12. When any of the control valves are in the closed state, the control valves are configured to prohibit the entire flow of a liquid through system 12. In some embodiments, any one of the control valves may be configured to modulate a flow of the liquid passing therethrough, thereby enabling a flow rate of the liquid to be adjusted and/or controlled.

In some embodiments, the first control valve 1302a, the second control valve 1302b, or both, are configured to couple with a control device 40 and facilitate the flow of a fluid from either control valve to the control device 40. The first control valve 1302a may be coupled to the control device 40 via a first mixture tube 1348a and the second control valve 1302b may be coupled to the control device 40 via a second mixture tube 1348b.

The control device 40 may include a mixture compartment located within the control device 40. The mixture compartment may be sized and configured to receive a sensor 60. Alternatively or additionally, the mixture compartment may be in fluid communication with a sensor 60. In additional or alternative embodiments, the third control valve 1302c is sized and configured to facilitate the flow of a liquid through the system 12. The control device 40 may be coupled to the third control valve 1302c via an elbow tube 1304. In some embodiments, the system 12 includes an output elbow 1340 fluidly coupled with the third control valve 1302c, the elbow tube 1304, or both. In additional or alternative embodiments, the control device 40 is coupled to the output port 1320. The control device 40 may be coupled to the output port 1320 via an output tube 1308.

In some embodiments, system 12 includes an electrical system 80. The electrical system 80 may include a PCB 1326, a power source, an actuator 1324, a display 1322, or combinations thereof. The PCB 1326 may be configured to receive at least an input. When the PCB 1326 receives an input, the PCB 1326 may be configured to provide an output. In some embodiments, the display 1322 is electronically coupled and communicatively coupled to the PCB 1326. The display 1322 may be configured to receive an input from the PCB 1326 and display an output determined by the PCB 1326.

In additional or alternative embodiments, the electrical system 80 includes one or more light-emitting diodes 1352 (LEDs) that is electronically coupled and communicatively coupled with the PCB 1326. The LEDs 1352 may be a plurality of LEDs 1352. In some embodiments, the LED(s) 1352 surrounds the actuator 1324. The LED 1352 may be configured to emit light in a pattern. In some embodiments, the pattern the LED 1352 emits are either circular, or spinning. The LEDs 1352 may be configured to display in a color selected by a user. In some embodiments, the LEDs 1352 are configured to display multiple colors.

Any internal component of system 12 may be configured to receive either direct current (DC) power or alternating current (AC) power. In some embodiments, the electrical system 80 is configured to provide AC power or DC power to any internal component or necessary electronics of system 12. The electrical system 80 may receive power from a power cord (as shown and described above in FIGS. 11A-F, e.g., 1112). In some embodiments, the electrical system 80 includes a voltage converter that is configured to convert AC power into DC power. The PCB 1326 may include the voltage converter. Benefits of the electrical system 80, including a voltage converter, may include the ability for system 12 to power some internal components through AC power while others are powered through DC power.

The electrical system 80 may include a first power supply 1350a and a second power supply 1350b. The first power supply 1350a and the second power supply 1350b may be communicatively coupled and electronically coupled with the electrical system 80. In some embodiments, the electrical system 80 is configured to provide the first power supply 1350a and the second power supply 1350b with DC power. In additional or alternative embodiments, the first power supply 1350a and the second power supply 1350b are electrically coupled to the first generator 50a and the second generator 50b. The first power supply 1350a may be electronically coupled to the first generator 50a via a second power supply cable 1344b. The second power supply 1350b may be electronically coupled to the second generator 50b via a first power supply cable 1344a. The first generator 50a and the second generator 50b may be configured to receive DC power from the electrical system 80.

In some embodiments, the first mixing device 30a, the second mixing device 30b, the sensor 60, the display 1322, the actuator 1324, the first control valve 1302a, the second control valve 1302b, the third control valve 1302c, the input port 1328, the output port 1320, the flow sensor 1330, and/or other similar internal onboard electronics are configured to receive power, which may include AC power, from the electrical system 80.

A flow sensor 1330 may be electronically coupled and communicatively coupled with the PCB 1326. In some embodiments, the flow sensor 1330 is configured to obtain a flow rate measurement when a fluid flows through the flow sensor 1330. The flow sensor 1330 may transmit the flow rate measurement to the PCB 1326. The PCB 1326 may be configured to provide an output when the PCB 1326 receives the flow rate measurement from the flow sensor 1330.

In additional or alternative embodiments, system 12 includes a sensor 60 located at least partially within a control device 40. The sensor 60 may include a sensor probe 1342 that may be located within the control device 40 and/or within a sensor housing 1346. The sensor 60 may be electronically coupled and communicatively coupled to the electrical system 80. In some embodiments, the sensor 60 is configured to couple with an electronic connector 1356 coupled to the electrical system 80. The electronic connector 1356 may be a sensor 60 connector, an ORP connector, and/or an ORP probe connector. The sensor 60 may be coupled to the PCB 1326 (e.g., communicatively coupled, physically coupled, or both). The sensor 60 may be configured to obtain data of a fluid (e.g., mixture and/or liquid) within the control device 40 and may be configured to transmit the data to the electrical system 80. The data that sensor 60 sends to the PCB 1326 may include an ORP level measurement of the mixture within the control device 40. In some embodiments, when the PCB 1326 receives data from the sensor 60, the PCB 1326 is configured to transmit the data to the display 1322. For example, when the sensor 60 sends an ORP measurement to the PCB 1326, the PCB 1326 may be configured to transmit the ORP measurement to the display 1322 to show the ORP measurement on the display 1322.

The sensor 60 may be configured to obtain an ORP measurement value between -2000 and 2000 millivolts (mV). In additional or alternative embodiments, the sensor 60 (e.g., treated liquid sensor) is configured to obtain an ORP measurement value between 0 and 2000 mV. In some embodiments, the electrical system 80 includes a set minimum threshold ORP measurement value, where when the sensor 60 obtains a measurement below the minimum threshold ORP measurement value, the LED displays a color, the display 1322 transmits a message, or both. Benefits of the electrical system 80, including a set minimum threshold ORP measurement value, may include warning a user when maintenance of the system 12 is needed and/or providing a warning that the ORP levels are below the minimum threshold. The set minimum threshold ORP measurement value may be from about 100 mV to about 1800 mV, such as from about 300 mV to about 1200 mV, from about 450 mV to about 950 mV, or about 650 mV. The set minimum threshold ORP measurement value may be 360 mV. In some embodiments, the LEDs 1352 is configured to project a color, such as for example, a yellow color when the electrical system 80 determines that system 12 needs maintenance and/or provides a warning to the user that the ORP levels are below the minimum threshold. The electrical system 80 may be an electronic system.

The display 1322 may be configured to receive an input from the PCB 1326 and may be further configured to display the input from the PCB 1326. In some embodiments, the display 1322 is configured to display an ORP level measurement obtained by the sensor 60. The display 1322 may be configured to display an ORP level measurement obtained by the sensor 60, including when the sensor 60 obtains an ORP level measurement below a minimum threshold (e.g., 650mV). In additional or alternative embodiments, when system 12 is idle, the display 1322 is configured to display “idle” or a similar message on the display. The display 1322 may be configured to display a message that instructs a user how to resolve an error the system 12 is experiencing. The display 1322 may be a screen, a LED panel, a tv, or a monitor.

The first control valve 1302a, the second control valve 1302b, the third control valve 1302c, or any combination thereof may be electronically coupled and communicatively coupled to the electrical system 80 via the PCB 1326. The first control valve 1302a, the second control valve 1302b, and/or the third control valve 1302c may have an open state and a closed state. When any of the control valves are in the open state, a fluid may be permitted to flow through the control valve and/or through system 12. When any of the control valves are in the closed state, a fluid will be blocked from flowing through the control valve, and in some cases, prevented from flowing through the system 12. Any of the first control valve 1302a, the second control valve 1302b, or the third control valve 1302c may be configured to be in the open state or the closed state under the first flow path or the second flow path (as described herein).

The system 12 may include a first flow path and a second flow path, for which fluid can flow through. In some cases, at least a portion of the first flow path and the second flow path are parallel to each other (as described herein). In some embodiments, the first flow path may be open and configured to allow fluid to flow therethrough when the actuator 1324 is not being activated (e.g., a user is not pressing the actuator 1324), and the second flow path is open and configured to allow fluid to flow therethrough when the actuator 1324 is activated (e.g., a user presses the actuator 1324).

Additionally or alternatively, the system 12 may include any number of flow paths, including a plurality of flow paths. As described herein, any system 12, 14 may include two flow paths. In other embodiments, the system 12, 14 may include one or more additional flow paths, thereby having 3, 4, 5, 10 or more flow paths. Each flow path may include one or more respective valves (which may be referred to as control valves herein), to help modulate the flow through each respective flow path. In some cases, any fluid may be configured to pass through one or more flow paths simultaneously. In some cases, the actuator 1324 is configured to select to choose any number of flow paths for fluid(s) to pass therethrough. In other embodiments, a system 12, 14 may only include one flow path, for a single end use (as described herein).

With respect to system 12, 14 (as described herein), in some cases, the flow rate through the first flow path may range from about 0.1 gallons per minute (gal/min) to about 10 gal/min (0.38 liters/min to about 37.85 liters/min), such as for example 1 gal/min (3.79 liters/min). In some cases, the flow rate through the second flow rate may range from about 0.01 gal/min to about 10 gal/min (0.039 liters/min to about 37.85 liters/min), such as for example about 0.5 or 0.6 gal/min (1.89 or 2.27 liters/min). As described herein, the mixing device 30a, 30b may be configured to at least partially, restrict the flow rate through each respective flow path, such that the flow rate through each flow path may be based on the respective mixing device 30a, 30b sizing and/or configuration.

In some cases, fluid may be configured to flow through the first flow path, where the first control valve 1302a is in the open state, while the second control valve 1302b is in the closed state, such that fluid may be prevented from flowing through the second flow path, and thereby placing the system 12 under the first flow path. In some cases, the third control valve 1302c may also be in the closed state when the first control valve 1302a is in the open state. In some embodiments, when the system 12 is under the first flow path, a liquid may be received by the fluid inlet system 1332 at the input port 1328, flow through system 12 via the first flow path, and exit system 12 at the output port 1320. Under the first flow path, the system 12 may be configured to receive a fluid from an external fluid source. In some embodiments, under the first flow path, the system 12 is configured to deliver fluid (e.g., water) to a laundry machine.

Accordingly, since the system 12 may be under the first flow path when the actuator 1324 is not activated, the system 12 may have a default operation to allow the fluid to flow through the first flow path.

When the actuator 1324 is activated, system 12 may be under the second flow path where the first control valve 1302a may be in the closed state, thereby preventing fluid from flowing through the first flow path, and the second control valve 1302b may be in the open state, thereby allowing fluid to flow through the second flow path. In some cases, under the second flow path, the third control valve 1302c may be in the open state. In some embodiments, when system 12 is under the second flow path, the system 12 is configured to receive a liquid from an external liquid source (which may still include receiving fluid from input port 1328) and dispense a fluid (e.g., a mixture including the liquid) at the output elbow 1340. Under the second flow path, system 12 may be configured to dispense a mixture at the fill system (as shown and described above in FIGS. 11A-F). As such, under the second flow path, the system 12 may be prevented in dispensing fluid at the outlet port 1320, thereby preventing the fluid from dispensing to a respective external component.

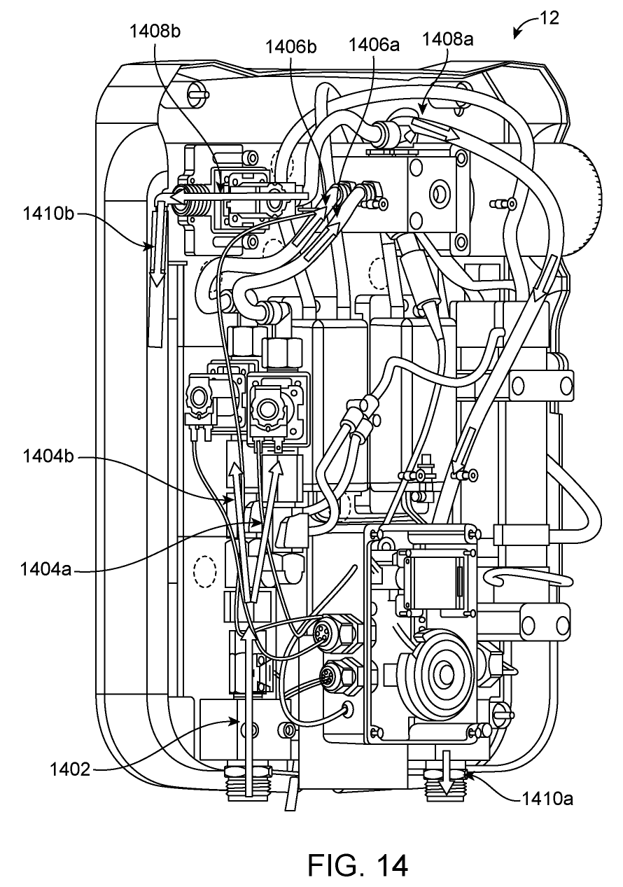

FIG. 14 illustrates a perspective view of a water oxidation system 12, according to some embodiments. Specifically, FIG. 14 depicts the flow of a fluid (e.g., liquid, which may be water for example) through system 12 as described with respect to the components as shown and described in FIGS. 13A-C. In some embodiments, when the system 12 is under the first flow path, the input port 1328 may intake a fluid 1402 from an external fluid source when the system 12 is activated. In some cases, the system 12 is activated when there is a demand for the fluid, such as, for example, the fluid is being drawn downstream of the input port 1328. For example, in cases where the system 12 is coupled to an external connection, such as a washing machine, via output port 1320, when the washing machine draws in water (e.g., it may open a valve within the machine or coupled to a fluid inlet line of the washing machine, as is the case for traditional washing machines), the water will automatically flow to the washing machine (which may be due to the higher pressure external source of the water). Accordingly, leaving the system 12 under the first flow path, allows an external connection (such as a washing machine) be able to draw in fluid as needed 1402, without worrying to have to separately turn on the system 12 or open valves therein.

With respect to the system 12 being under the first flow path, after the input port 1328, the fluid may then flow 1402 to a flow sensor 1330 and to a first mixing device 30a1404a, where the fluid may be mixed with a gas to create a mixture (as described herein, and which may be referred to herein as a treated liquid). Because the system 12 is under the first flow path, the first control valve 1302a is in an open state where the mixture may then flow 1406 from the first mixing device 30a, through the first control valve 1302a, and into the control device 40 through a first mixture tube 1348a. From the control device 40 (as described further herein), the mixture then flows 1408a to the output port 1320 via an output tube 1308 because the third control valve 1302c may be in the closed state. The mixture then exits the output port 1320 and flows 1410a to an external connection. In some embodiments, the external connection is a laundry machine (e.g., washing machine, as described herein).

By contrast, the system 12 may be under the second flow path, where when the actuator 1324 is actuated (e.g., a user presses the actuator), the first control valve 1302a may be transitioned to a closed state, while the second control valve 1302b and/or third control valve 1302c may be transitioned into an open state. When system 12 is activated, the input port 1328, may receive a fluid 1402 from an external fluid source, where the fluid may then proceed into system 12. Similar to under the first flow path, the system 12 may be activated when an external connection is configured to draw fluid through the system, which may be via output elbow 1340 (which may correspond with fill station 1104). For example, where the fill station 1104 includes a hose, once the hose is actuated to allow fluid to pass therethrough (to be dispensed), fluid is then drawn through the system 12 (e.g., again, which may be due to the higher pressure of the fluid source, such as water pressure of the external source).

The fluid inlet system 1332 may be configured to fluidly couple with the external fluid source and receive 1402 the fluid from the external fluid source (which may be similar whether the system 12 is under the first flow path and/or the second flow path). After the input port 1328, the fluid may then flow 1402 through the flow sensor 1330, and to a second mixing device 30 b (instead of the first mixing device) where the fluid may be mixed with a gas to create a mixture, because the first control valve 1302a may be in the closed state and a second control valve 1302b may be in an open state. The mixture may then flow 1406 into the control device 40 via a second mixture tube 1348b. Under the second flow path, the third control valve 1302c may be in the open state where the third control valve 1302c may permit the mixture to flow 1408b from the control device 40, and then flow 1410b to an output elbow 1340. The system 12 may include an elbow tube 1304 fluidly coupled to the control device 40 and may be configured to facilitate the flow 1408b of the mixture from the control device 40 to the output elbow 1340. Once the mixture flows 1408b to the output elbow 1340, the mixture may be dispensed 1410b by a user directly out of the output elbow 1340, or the mixture may flow 1410b through a nozzle hose and into a nozzle 1338 (as shown and described in FIGS. 23A and 23B). Arrows and their respective component numbers (for the arrows) are depictured in FIG. 14, for reference to show the path of a liquid (e.g., liquid, mixture [treated liquid], water) through system 12.

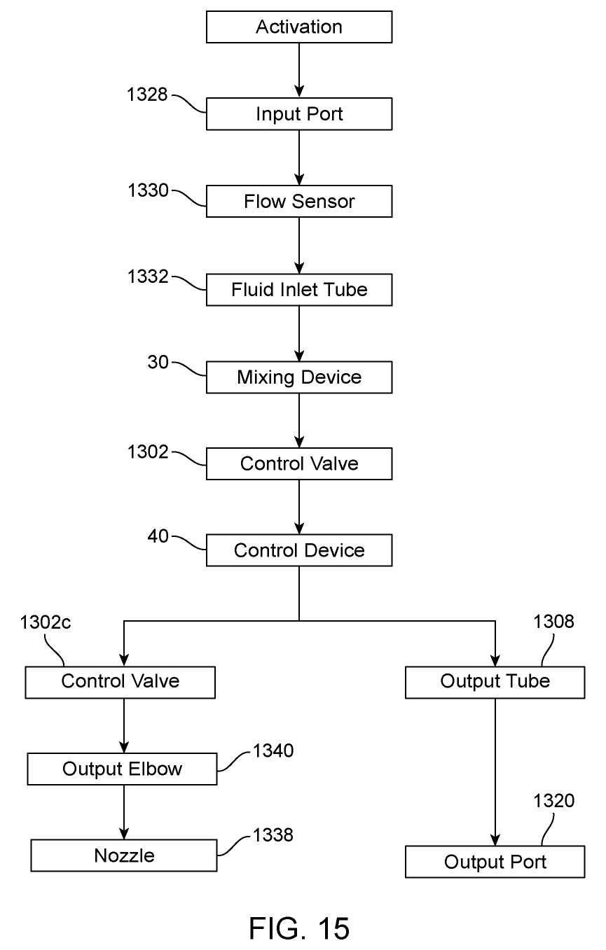

FIG. 15 illustrates a block diagram of a water oxidation system 12 depicting the flow of a liquid, according to some embodiments. Specifically, as shown in FIG. 15, system 12 may be fluidly coupled to an external water source, whereupon activation (e.g., fluid being drawn through the system 12, which may be due to an external connection and/or an outlet opened), fluid (e.g., water) flows from the external water source and into system 12 at the input port 1328. The water then flows from the input port 1328 to a flow sensor 1330. Then, dependent on whether the actuator 1324 has been actuated, the water flows from the flow sensor 1330 into a mixing device 30 (i.e., either a first mixing device 30a if under the first flow path, i.e., actuator is not actuated, or a second mixing device 30b if under the second flow path, i.e., actuator is actuated). The control valves 1302 a,b,c may permit or prevent the water from flowing through the system 12, dependent upon the flow path. At either mixing device 30a, 30b, the water is combined with a gas to form a mixture (e.g., a treated liquid). The mixture then proceeds from a mixing device 30a, 30b to a control device 40.

As described further herein, the first and second flow paths may rejoin within or about the control device 40, before being split again.

Where the mixture flows through after the control device 40 may be dependent upon the flow path that the system 12 is under. Under the second flow path, the mixture may proceed to the third control valve 1302c via the elbow tube 1304, and then to the output elbow 1340. In some embodiments, the mixture then flows from the output elbow 1340 to the nozzle 1338 (which may be fill station 1104 or coupled thereto as described herein), which may be fluidly coupled with an external connection (as described herein), other fluid receiver (including, for example, a bucket), or another means to dispense the fluid (e.g., a hose). Under the first flow path, the mixture may proceed to the output port 1320 via the output tube 1308. From the output port 1320, the mixture may then flow into an external connection (e.g., an external device, external component, as referred to herein). In additional or alternative embodiments, the external device is a laundry machine, a dishwasher, a drinking water outlet, ice machine, vehicle (e.g.,. RV), cleaning (e.g., hosing down equipment, countertops, etc.) and/or any other machine.

In some embodiments, liquid flow pathway from the input port 1328 includes an orifice configured to adjust the flow rate of a liquid flowing through the system 12. The system may include a plurality of orifices. The orifice may be an orifice plate. In additional or alternative embodiments, the orifice may be located between the mixing devices (i.e., the first mixing device 30a, and the second mixing device 30b) and the input port 1328. An orifice may be configured to adjust and/or otherwise influence the flow rate of a liquid flowing through the system 12 by increasing or decreasing the flow rate of the fluid flowing through the system 12.

With respect to any system described herein, the mixing device (e.g., 30a, 30b) may each include a respective orifice for i) restricting a flow rate through the respective flow path, and/or ii) creating a venturi effect so as to pull the gas (e.g., provide a motive force for the gas to flow through the system).

The flow rate of a liquid flowing through system 12 (e.g., flow rate through each flow path) may be adjusted by the size of the orifice(s) along each flow path, and/or the quantity of orifices. For example, increasing the quantity of orifices may decrease the flow rate of a fluid flowing through system 12. In some embodiments, the flow rate of a liquid flowing through system 12 is adjusted by increasing or decreasing the size of an orifice. An orifice may be configured to define a flow rate (which may be based on a pressure of the fluid [e.g., liquid] from the external source). In some embodiments, the flow rate of a liquid flowing through system 12 is a fixed flow rate. The flow rate of a liquid flowing through system 12 may be a fixed flow rate, a fixed size flow rate, a fixed for size flow rate, a fixed or for size flow rate, a fixed quantity flow rate, and/or a fixed amount flow rate. In additional or alternative embodiments, the flow rate is a constant flow rate. The flow rate may be adjusted by swapping an internal component. The flow rate may be adjusted by swapping an orifice.

As described herein, each mixing device 30a, 30b may include an orifice. The first mixing device 30a may include a first orifice and the second mixing device 30b may include a second orifice. The first orifice and the second orifice may be sized and/or configured to have different flow rates (e.g., thereby resulting in different flow rates through the first and second flow paths, as described herein). As, the first orifice may be configured to allow for a higher flow rate therethrough than the second orifice, so as to allow the system under the first flow path to have a higher flow rate of the mixture (e.g., treated liquid) than when the system is under the second flow path.

Moreover, as described herein, each mixing device 30a, 30b may be configured to promote a venturi effect, wherein a restriction in the respective flow path (e.g., the first, second orifice) may help increase the liquid velocity, while also creating a low-pressure zone about the respective mixing device. The low-pressure zone (which may be at a vacuum, a partial vacuum, etc.) may be in fluid communication with the gas flow pathway, wherein the pressure differential between the gas at the inlet (e.g., 1320 – and which may be at higher pressure, such as atmospheric pressure) and the pressure at the low-pressure zone, create a motive force for the gas to flow from the inlet 1320, through the generators 50a, 50b, to the respective mixing device. The first orifice, the second orifice, or both, may be sized and/or configured to create a low-pressure zone.

By contrast, the motive force for the liquid to flow through the system may be from the external source (e.g., pressure in a water pipe), which push the liquid through the system when the outlet (e.g., a laundry machine, hose, etc.) is open so as to create the pressure differential between the external liquid source pressure and the outlet (e.g., external connection, hose) pressure. Accordingly, a flow rate of the liquid through the system may be specified, or reasonably specified, by taking into account the external source pressure, and specifying an appropriate orifice size (e.g., for the first and/or second orifice). As such, each of the first flow path and the second flow path may be configured for respective flow rates (or approximately) and/or a proportional difference in respective flow rates based on an orifice size.

In some cases, the first mixing device 30a includes a first orifice having a cross-sectional area that is from around 0.5 to about 5 times the size of a cross-sectional area of a second orifice (of the second mixing device 30b), which may include from about 2 to about 3 times the size. Accordingly, the ratio of the flow rate through the first flow path as compared to the second flow path may be proportional to the ratio between the cross-sectional areas of the first and second orifices (e.g., proportional when calculating the flow through each orifice based on the available cross-sectional area).

In additional or alternate embodiments, the first flow path and/or the second flow path may each include one or more orifices that are separate from the respective mixing device 30a, 30b, wherein each of one or more optional orifices (for the first flow path and/or the second flow path) may be configured to restrict a liquid flow rate through the respective flow path. For example, in such cases, the mixing device may not include an orifice, and/or may include an orifice that is not the sole, primary, and/or effective means of reducing the flow through each respective flow path. Accordingly, the disclosure here regarding the differences in cross-sectional area between mixing device orifices (for the first and second flow path) would also be applicable for such optional orifices that may be located separate from the mixing devices 30a, 30b.

The first mixing device 30a, the second mixing device 30b, or both, may include a T-configuration (e.g., a tee connection). The t-configuration may be sized and/or configured to include at least an orifice sized and/or configured dependent upon the flow path. In some cases, the T-configuration includes the liquid to flow through the straight part of the T (e.g., horizontal), while the perpendicular (or substantially perpendicular) portion of the T (e.g., vertical) that intersects the straight part of the T includes an inlet for the gas to enter the respective mixing device. In other embodiments, the gas inlet may be in any other orientation or configuration (i.e., instead of a T-configuration) when connecting to the liquid flow pathway within the respective mixing device, wherein such other configuration may still be configured to allow for the low-pressure zone to draw in the gas.

In some cases, the gas inlet to each mixing device (e.g., 30a, 30b) is located about the low-pressure zone created by the liquid and restriction point (e.g., respective orifice). In some cases, for each mixing device (e.g., 30a, 30b), the orifice (e.g., first and/or second orifice) and the T-configuration (or any other configuration) may be provided as a singular component. In other cases, for each mixing device, the orifice may be a separate component from the T-configuration (or any other configuration), and coupled together.

In some embodiments, the first flow path includes a first flow rate and the second flow path includes a second flow rate. The first flow rate and the second flow rate may be different. In additional or alternative embodiments, either flow rate is measured in gallons per minute. The first flow rate may be higher than the second flow rate. In some embodiments, the first flow rate is based on a size and/or configuration of the first mixing device 30a, while the second flow rate may be based on a size and/or configuration of the second mixing device 30b. In some embodiments, the first flow rate is sized and/or configured for an external component. The second flow rate may be sized and configured for a fill system (as shown and described above in FIGS. 11A-F). The first flow rate may be a washing machine flow rate, and the second flow rate may be a flow rate lower than the washing machine flow rate. In additional or alternative embodiments, the second flow rate is a bottle fill flow rate, a fill station flow rate, a fill tube flow rate, a fill-U-tube flow rate, or a flow rate configured by a user.

The flow rate (or maybe herein referred to as a volumetric flow rate) of the first flow path or the second flow path may be determined by multiplying a cross-sectional area (e.g., the cross-sectional area of the first mixing device 30a and/or the second mixing device 30b), by the average fluid velocity. The size ratio of the first and second mixing device 30a, 30b may be used to determine a corresponding ratio between the flow rate through each flow path (as described herein). For example, the size ratio of the first and second mixing device may be multiplied by the velocity of water entering the system 12 to obtain a flow rate ratio of both flow paths.

In some embodiments, the flow rate of a liquid flowing through system 12 is adjusted by the input port 1328. The input port 1328 may be an inlet or an inlet port. The flow rate of the liquid flowing through the system 12 may be based on a water pressure of the external fluid source, an inlet water pressure, and/or an external component liquid pressure.

In additional or alternative embodiments, the flow rate of a liquid flowing through system 12 when system 12 is under the first flow path is a flow rate based on an external fluid source. In some embodiments, the external fluid source is a water intake for a washing machine (i.e., laundry machine), and the flow rate is the flow rate of water the washing machine uses. When the system 12 is under the second flow path, the flow rate may be a set flow rate. In some embodiments, the electrical system 80 is configured to adjust the set flow rate. In additional or alternative embodiments, when the system 12 is under the second flow path, the flow rate is lower than the flow rate when the system 12 is under the first flow path.

As described herein, each mixing device 30a, 30b, may be sized to restrict an amount of flow of the fluid. In some cases, the mixing device 30a, 30b may be a venturi injector (or a venturi valve, or other device that induces a venturi effect), which may be configured to restrict a flow rate of a liquid, while also drawing in a gas to form a mixture. Accordingly, a flow rate of a mixture may be restricted based on a sizing of the venturi injector 30a, 30b (as described further herein). As used herein, venturi injector may be used interchangeably with venturi valve, through either type of venturi device (venturi injector, venturi valve) may be used with any system described herein, and/or any other type of device that promotes a venturi effect.

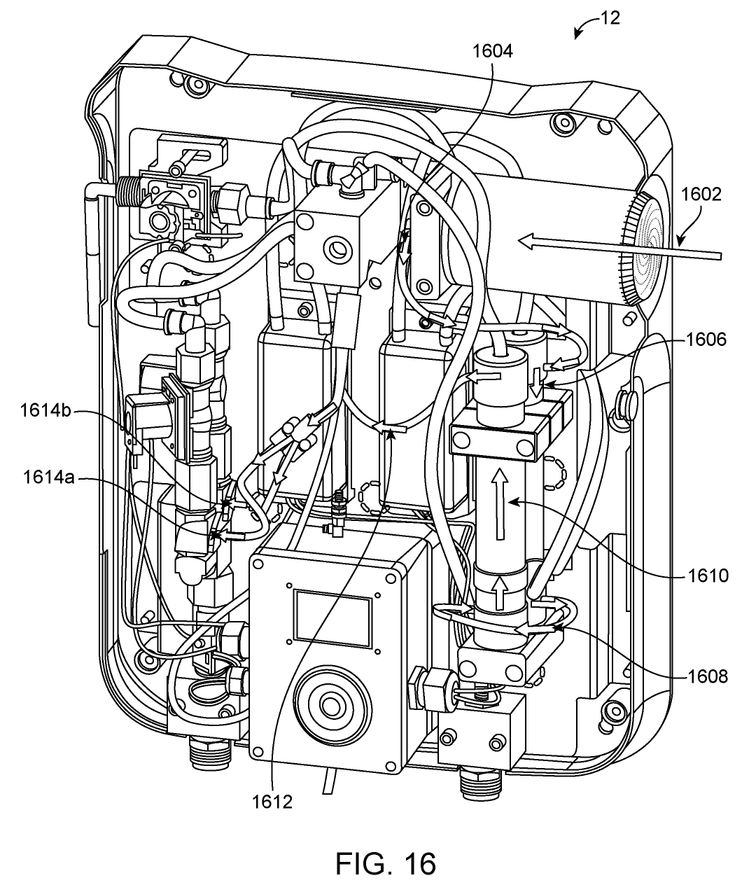

FIG. 16 illustrates a perspective view of a water oxidation system 12 depicting the flow of a gas through the water oxidation system 12, according to some embodiments. As shown in FIG. 16, a gas may enter 1602 the system 12 at a container inlet 1310 (which may be referred to as a gas inlet or second inlet). The gas may then flow 1602 through the container 20 and into a container outlet 1306. The container outlet 1306 may be fluidly coupled to a first generator 50a by a first gas tube 1312. The gas from the container outlet 1306 may flow 1604 through the first gas tube 1312 and into the first generator 50a. The first generator 50a and the second generator 50b may be fluidly coupled together by a second gas tube 1314. After the gas flows 1606 through the first generator 50a, the gas may flow 1608 through the second gas tube 1314 and into the second generator 50b. The gas may then flow 1610 through the second generator 50b. As described herein, each generator may be configured to process the gas, so as to produce processed gas. In some embodiments, the second generator 50b is fluidly coupled with a y-valve 1336 by a third gas tube 1316. From the second generator 50b, the gas (e.g., processed gas which flows from the generator) may flow 1612 through the third gas tube 1316 and into the y-valve 1336. The y-valve 1336 may be fluidly coupled to the first mixing device 30a by a fourth gas tube 1334a. In additional or alternative embodiments, the y-valve 1336 is fluidly coupled to a second mixing device 30b by a fifth gas tube 1334b. Dependent on the method of system activation (which may include whether the actuator 1324 is actuated, as described herein), the gas (e.g., processed gas) may then flow 1614a from the y-valve 1336 into a first mixing device 30a via the fourth gas tube 1334a, or the gas may flow 1614b to the second mixing device 30b via the fifth gas tube 1334b. Arrows and their respective component numbers (for the arrows) are depictured in FIG. 16, for reference to show the path of the gas (e.g., gas, processed gas) through system 12.

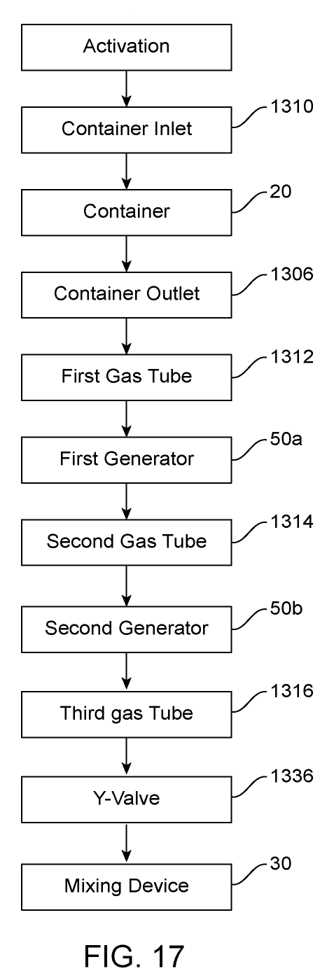

FIG. 17 illustrates a block diagram of the water oxidation system 12 depicting the flow of a gas, according to some embodiments. In the embodiment as shown in FIG. 17, the system 12 may be under a first flow path, or a second flow path (as described above in FIGS. 13A-C). In some embodiments, a container inlet 1310 is configured to receive an external gas. The external gas may be air. Upon activation of the system 12 (as described herein), the external gas may enter the container inlet 1310 and flow through a container 20 and into a container outlet 1306. As described herein, the mixing device 30a, 30b may be configured to pull a vacuum (or at least reduced pressure) to draw in the gas via the gas flow path. For example, the mixing device 30a, 30b may be a venturi valve (or maybe herein referred to as a venturi injector, as described herein), which, once having a liquid pass therethrough, is configured to draw in the gas (i.e., this provides the intake force for the gas to be drawn in through the container inlet 1310).

In additional or alternative embodiments, the container 20 is configured to dehumidify the gas as it passes through the container 20. As described herein, the container 20 may include a desiccant to enable the gas to be dehydrated and/or dehumidified. The gas, after exiting the container outlet 1306, may flow into a first gas tube 1312 and into a first generator 50a. The gas may then flow through the first generator 50a into a second gas tube 1314 and into a second generator 50b. After the gas passes through the second generator 50b, the gas (e.g., processed gas) may then flow into a third gas tube 1316 and into a y-valve 1336. Dependent on whether the system 12 is under the first flow path or the second flow path, the gas may then flow from the y-valve 1336 to a first mixing device 30a by a fourth gas tube 1334a or flow to a second mixing device 30b by a fifth gas tube 1334b.

The first gas tube 1312, the second gas tube 1314, the third gas tube 1316, the fourth gas tube 1333a, the fifth gas tube 1334b, or combinations thereof, may be sized and configured such that the distance the gas flows within any of the tubes is minimal. For example, the first gas tube 1312 may be sized and configured such to minimize the distance gas (e.g., dehumidified air) flows from the container outlet 1306 to the first generator 50a. Benefits of sizing and/or configuring any of the gas tubes such that the distance a gas travels within it is minimized may include reduction in loss of ozone due to time, and/or reducing an amount of pressure loss of the gas flow (which may reduce an amount of gas flow rate).

In some embodiments, the first generator 50a and the second generator 50b are in a series configuration where the gas passes entirely through the first generator 50a before going into the second generator 50b and flowing through the entirety of the second generator 50b. In additional or alternative embodiments, the first generator 50a and the second generator 50b (for any system described herein) may be configured to excite the gas by emitting an electrical current or charge through the gas and excite the molecules. In some cases, each generator 50a, 50b may be configured to generate a high voltage potential (e.g., between electrodes), such that when air passes through, the gas may be excited, where at least some of the gas molecules may change form. The gas may be air, whereupon passing through the first generator 50a and the second generator 50b, the air molecules may be excited to form ozone (e.g., the oxygen in the air may be converted into ozone). Accordingly, the processed gas may correspond to ozone, which may be mixed with the liquid (e.g., water), via the mixing device 30a, 30b, to produce treated liquid (e.g., treated liquid). Other means of processing the gas (e.g., converting oxygen to ozone) may be included, such as using UV light, and/or others. In some embodiments, the first generator 50a is a first gas generator 50a. The second generator 50b may be a second gas generator 50b. The first generator 50a and/or the second generator 50b for any system described herein (e.g., 10, 12, 14) may be an ozone generator.

Benefits of the gas passing through the first generator 50a and the second generator 50b in series may include any residual non-excited gas molecules that pass through the first generator 50a being excited in the second generator 50b, resulting in a gaseous mixture that is entirely, or almost entirely, excited gas molecules (which may result in more ozone content in the gas flowing to the mixing devices 30a, 30b). For example, when air passes through the first generator 50a, the air is excited to form ozone, but after flowing through the first generator 50a, there may still be some air (e.g., oxygen in the air) that was not converted to ozone. By passing through the second generator 50b, the remaining residual, unconverted air (that is mixed with the ozone generated from the first generator 50a) may be excited such that the resulting gaseous mixture includes even more ozone. In some cases, after passing through both the first and second generators 50a, 50b, the oxygen in the air may be completely, or almost completely, converted into ozone. The first generator 50a, the second generator 50b, or both may be corona discharge ozone generators.

In some embodiments, the first flow path includes a first gas flow rate and the second flow path includes a second gas flow rate. Both the first gas flow rate and the second gas flow rate may be fixed. In some embodiments, the first gas flow rate is defined by the first mixing device 30a and the second gas flow rate is defined by the second mixing device 30b. The first gas flow rate may be based on a washing machine flow rate, and the second gas flow rate may be different (e.g., higher or lower) than the first gas flow rate. For example, the second gas flow rate may be based on a fluid flow rate that is different than the washing machine flow rate. In some embodiments, the second gas flow rate is based on a fill tube flow rate, a bottle fill flow rate, a fill-U-tube flow rate.

The first gas flow rate may be adjusted by the first mixing device 30a. In additional or alternative embodiments, the second gas flow rate is adjusted by the second mixing device 30b. In some embodiments, the first mixing device 30a, the second mixing device 30b, or both, is a venturi.

Both the first mixing device 30a and the second mixing device 30b may be configured to define a low-pressure zone (e.g., a venturi valve that creates a low-pressure zone to pull in the gas). The first gas flow rate and the second gas flow rate may be adjusted by the low-pressure zone defined by the first mixing device 30a and the second mixing device 30b respectively. In additional or alternative embodiments, the first gas flow rate and the second gas flow rate are adjusted by at least a pressure differential defined by the flow rate of a liquid flowing through either the first mixing device 30a or the second mixing device 30b.

In some embodiments, when the system 12 activated (as described herein), the flow path of the system 12 determines the rate that gas (e.g., air), flows through the system 12 before being injected at the mixing device and combined with the fluid (e.g., liquid from input port 1328) to form the mixture. When the system 12 is under the first flow path, the first mixing device 30a may define the first gas flow rate. In some embodiments, the first mixing device 30a defines a first gas flow rate sufficient to oxidate (e.g., ozonate) the fluid flowing through the first flow path, to achieve a minimum ORP level (as described herein). When the system 12 is under the second flow path, the second mixing device 30b may define the second gas flow rate. In additional or alternative embodiments, the second mixing device 30b defines a second gas flow rate sufficient to oxidate (e.g., ozonate) the fluid flowing through the second flow path, to achieve a minimum ORP level (as described herein). In some embodiments, the first gas flow rate is defined by a first mixing device 30a sized and configured for delivering fluid to an external component. The external component may be a washing machine, dishwasher, etc. In additional or alternative embodiments, the second gas flow rate is defined by a second mixing device 30b sized and configured for delivering fluid to a fill system (as shown and described above in FIGS. 11A-F). The fill system may be sized and configured to output to a bottle or container.

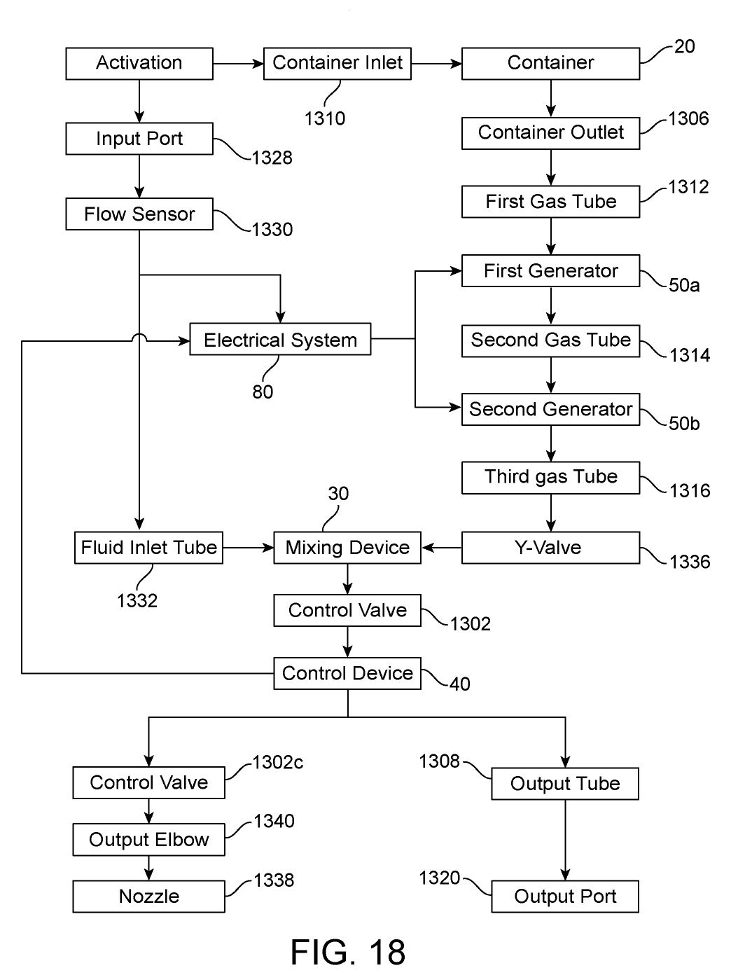

FIG. 18 illustrates a block diagram of a water oxidation system 12 depicting the flow of both a liquid and a gas therethrough, so as to create a mixture, according to some embodiments. Herein described, for the purpose of describing the flow of the liquid and the gas through the system 12, the liquid is water, and the gas is air, so as to ozonate the water, and thereby deliver ozonated water to a downstream receiver (which may be an external connection, a hose, a bottle, etc.). As shown in FIG. 18, upon activation of the system 12 (as described herein), water from an external water source may enter the system 12 at the input port 1328. Concurrently, air may enter the system 12 through the container inlet 1310, flowing through the container 20, and exiting the container 20 at the container outlet 1306. As the air passes through container 20, the air may be dehumidified and moisture may be removed. This may result in dehumidified air at the container outlet 1306. From the container outlet 1306, the dehumidified air may then flow through the first gas tube 1312 and into the first generator 50a.

Concurrently, as the dehumidified air is entering the system 12 and passing through the container 20 to the first generator 50a, water may flow from the input port 1328 to the flow sensor 1330, where the flow sensor 1330 may obtain a flow rate measurement. The flow sensor 1330 may communicate the flow rate measurement with the electrical system 80. From the flow sensor 1330, the water then proceeds through the fluid inlet system 1332 and into a mixing device 30a, 30b. When the system 12 is under a first flow path, the water may flow into a first mixing device 30a. In some embodiments, when the system 12 is under a second flow path, the water flows into a second mixing device 30b.

As described herein, the electrical system 80 may be configured to transition the open or closed position of any one or more of control valves 1302a, 1302b, and 1302c.

As the water flows through the flow sensor 1330 and through a mixing device (30a, 30b), air may be pulled, via the mixing device, so as to flow through the first generator 50a, where air molecules (O2) are being excited to form ozone (O3) and form a gaseous mixture. From the first generator 50a, the gaseous mixture may flow through a second gas tube 1314 and into a second generator 50b. When the gaseous mixture flows through the second generator 50b, at least some of the remaining air molecules may be excited, forming ozone. This may result in a gaseous mixture having ozone, and in some cases, where the gaseous mixture has entirely or almost entirely converted the oxygen to ozone as the gas exits the second generator 50b, after which it flows through a third gas tube 1316, and into a y-valve 1336 and into a respective mixing device 30a, 30b.

Under either flow path, the water in the mixing device 30a, 30b may be mixed with the gaseous mixture to form a water-ozone mixture. Herein described, the water-ozone mixture will be referred to as “mixture.” From the mixing device 30a, 30b, dependent upon the method of activation (which may include the actuator 1324 being actuated), the mixture may pass through a control valve 1302a, 1302b and flow into the control device 40.

The control device 40 may include and/or be in fluid communication with a sensor probe 1342 of a sensor 60, which may be electronically coupled and communicatively coupled with the electrical system 80. In some cases, the control device 40 may include a receiving compartment or chamber configured to receive the mixture from both the first flow path (e.g., via, first mixture tube 1348a) and the second flow path (e.g., via second mixture tube 1348b). Thus, the first flow path and the second flow may first split after the flow sensor 1330, then go through each respective mixing device, and control valve, before rejoining in the control device 40 chamber. The chamber may then be fluidly coupled with the output tube 1308 (first flow path) and the elbow tube 1304 (second flow path). The chamber may also be coupled with the sensor 60, which may include a separate tubing that allows the mixture to flow to the sensor 60.

The sensor probe 1342 may be configured to obtain an ORP measurement level of the mixture (e.g., treated liquid) when the mixture flows past the sensor probe 1342. The sensor probe 1342 may be configured to communicate the ORP measurement to the electrical system 80. In additional or alternative embodiments, the first generator 50a and the second generator 50b are configured to receive an input from the electrical system 80. The electrical system 80 may be configured to receive data (e.g., the water flow rate) from the flow sensor 1330 and the sensor 60 (e.g., the ORP measurement level of the mixture). In some cases, the flow rate of the mixture, the ORP measurement, and/or an indication of whether the ORP value of the mixture is above a minimum threshold may displayed via the system 12. In some cases, such indications may all be separate (e.g., display, LEDs, etc.), or may be combined (e.g., via display, LEDs, etc.).

In alternate or additional embodiments, depending on the ORP measurement level of the mixture within the control device 40, the electrical system 80 may adjust the flow of water through the system 12, the amount of air intake into the system, the amount of air excitement within the generators, or a combination of the methods, to obtain a desired ORP measurement level.

From the control device 40, the mixture may then flow to an output elbow 1340 or an output port 1320 (as described herein, and which may be referred to as a first outlet) dependent on whether the system 12 is under the first flow path or the second flow path. If an actuator 1324 is not activated, the system 12 may be under the first flow path, where the mixture may flow from the control device 40 to the output port 1320, where the mixture may exit the system 12. In some embodiments, the mixture flows from the control device 40 to the output port 1320 through an output tube 1308. The mixture may flow from the output port 1320 to an external connection. In some embodiments, when the actuator 1324 is activated (e.g., actuated), the system 12 is under the second flow path where the mixture exits the system 12 through the output elbow 1340 (which may be referred to as a second outlet). The mixture may flow from the output elbow 1340 to an external connection. The mixture may flow from the control device 40 to the elbow tube 1304, passing a third control valve 1302c in an open state, into the output elbow 1340, where the mixture may then be dispensed by a user or flow into a nozzle hose and into a nozzle 1338.

In some embodiments, the elbow tube 1304 is fluidly coupled with the control device 40, the third control valve 1302c, or both. The third control valve 1302cmay be fluidly coupled with the output elbow 1340. The nozzle 1338 may be fluidly coupled with the output elbow 1340. In additional or alternative embodiments, the output tube 1308 is fluidly coupled with the control device 40, the output port 1320, or both. The output elbow 1340 may be a solenoid valve or a mechanical valve.

As fluid flows through the system 12 and the mixture is created and flowing to its respective output, the sensor 60 may obtain an ORP measurement below, at, or above a desired ORP measurement level. The fluid may continue to flow through system 12 to its respective output continuously, regardless of whether the ORP measurement is at the desired ORP level. For example, the system 12 may be under the first flow path when the mixture flows out of system 12 though output port 1320 to a washing machine, where the flow rate of the fluid may be determined by the flow rate of water used by the washing machine (which may also be determined via the flow sensor 1330), and/or the gas flow rate (i.e., first gas flow rate), which may be determined by the first mixing device 30a, which may be sized and configured to define a gas flow rate for the washing machine (based on an expected water flow rate, which may be based in part on the water pressure, flow orifice(s), and backpressure buildup in the flow path downstream of the mixing device). By contrast, the system 12 may be under the second flow path when the mixture flows out of system through the fill system (as shown and described above in FIGS. 11A-F) or the output elbow 1340, where the flow rate of the fluid may be determined by a set flow rate used by the fill system (and/or may be determined via flow sensor 1330), and the gas flow rate (i.e., second gas flow rate), which may be determined by the second mixing device 30b, which may be sized and configured to define a gas flow rate for the fill system (based on an expected water flow rate, which may be based in part on the water pressure, flow orifice(s), and backpressure buildup in the flow path downstream of the mixing device). In some embodiments, the fill system outputs to water bottles, the flow rate of the fluid is sufficient for a user to dispense the mixture into a water bottle and the gas flow rate (i.e., second gas flow rate) is sufficient achieve an ORP level in the mixture for a user using the water bottle.

Accordingly, although the amount and/or rate of water and/or air flowing via the respective mixing device 30a, 30b may be different from each other, in some cases, the ORP value of the mixture (and/or target ORP value) is the same regardless of whether the system 12 is under the first flow path or the second flow path. Thus, at least one difference between the first flow path and the second flow path is to provide different mixture flow rates. For example, the first flow path may allow for a higher flow rate, while the second flow path (which may be for example for bottle filling) may benefit from a lower flow rate. The vice versa may also be true.

In alternate or additional embodiments, the first and second flow paths may have different target ORP levels, which may be influenced by the mixing device (e.g., varying proportional sizes of a venturi valve, where more or less air is pulled via the low-pressure zone).

The system 12, when activated under either flow path may enter an error state. In some embodiments, system 12 is configured to facilitate a user resolving the error state. The system 12 may facilitate a user resolving the error state by displaying an error message and/or instructions to resolve the error through the electrical system 80. The electrical system 80 may display the error message and/or instructions on the display 1322. For example, a user may activate the system using actuator 1324 (e.g., pressing a push-button actuator), setting the system 12 under the second flow path. The system 12 may not detect water flowing through system 12 and go into the error state where the first generator 50a, the second generator 50b, both, or other internal components may shut off. The system 12 may be configured to instruct the user to clear the error by displaying on the electrical system 80 display 1322, instructions for the user. For example, this may include for the user to continuously activate the actuator 1324 (e.g., hold the push-button actuator) for a determined amount of time (e.g., 5 seconds) to reinitiate the system 12 and which may start the system 12 in a normal state (e.g., the first flow path or the second flow path).

In some embodiments, the elbow tube 1304, the output tube 1308, the fluid inlet system 1332, or combinations thereof are sized and configured such that the distance fluid or mixture flows is minimal. For example, the output tube 1308 may be sized and configured to minimize the distance the mixture travels from the control device 40, to the output port 1320. Benefits of sizing and/or configuring any of the elbow tube 1304, the output tube 1308, the fluid inlet system 1332, or combinations thereof, such that the distance a gas travels within it is minimized may include reduction in loss of ozone due to time, and/or losses in fluid pressure losses that may impact fluid flow rate.

Any tube or internal component involved in either the first flow path or the second flow path may be sized and configured such that the distance a gas, liquid, mixture, or combinations thereof, flowing through the system 12 is minimized. For example, the elbow tube 1304 may be sized and configured such that the distance the mixture flows within the elbow tube 1304 from the control device 40 to the output elbow 1340 is minimized. Benefits of sizing and/or configuring any tube or internal component involved in either flow path may include minimizing the amount of ozone loss the mixture of ozonated water may experience when flowing through the system 12, and reduced frictional losses in the respective flow path (as described herein). Another benefit of sizing and or configuring any tube or internal component involved in either flow path and its respective needs may include replacing any stagnant mixture (e.g., mixture that has remained in the system 12 for some time and became less ozonated or even lost all ozone returning to water) with a properly ozonated mixture.

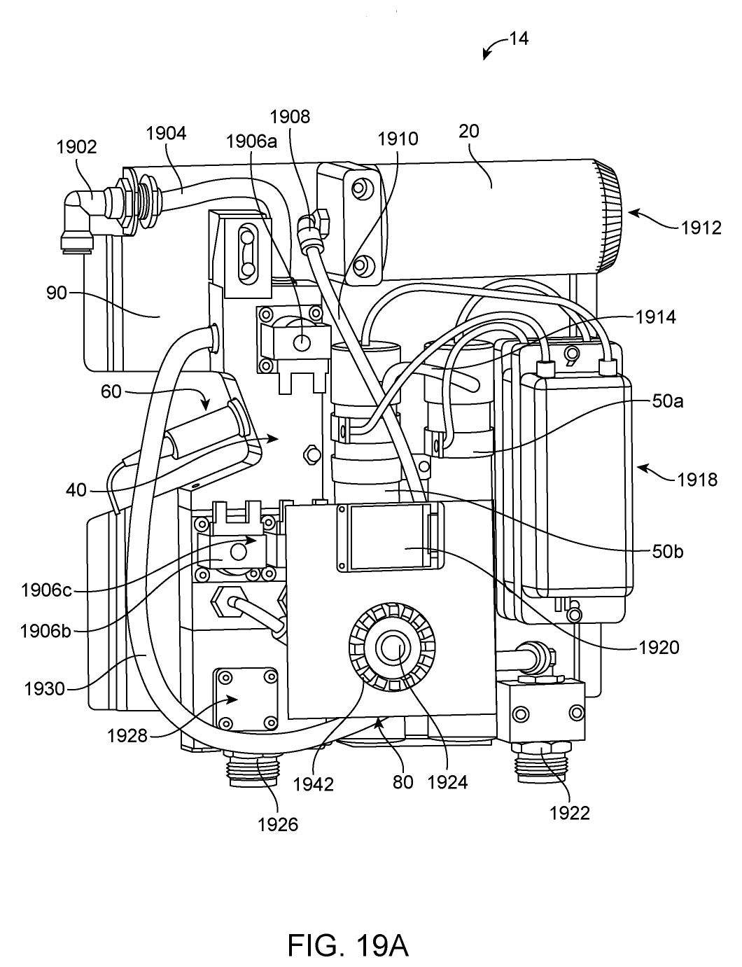

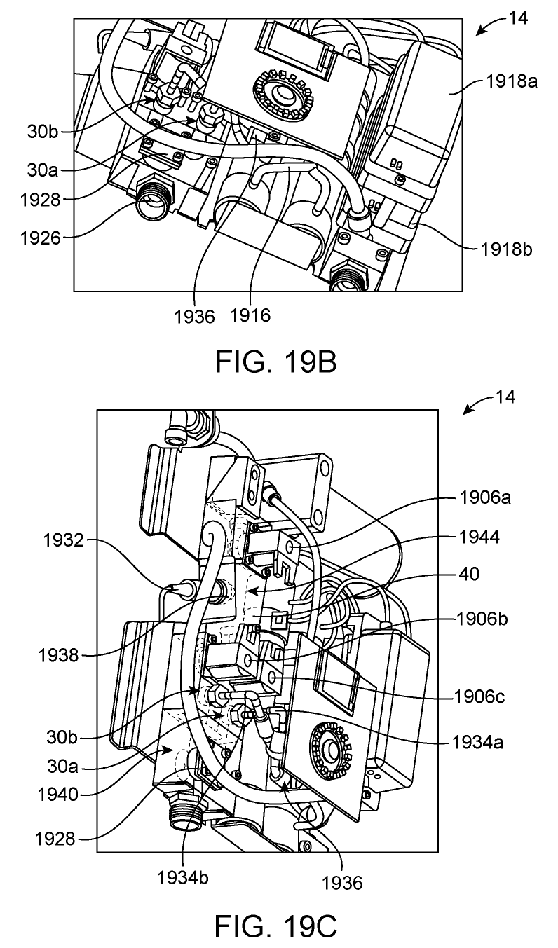

FIG. 19A illustrates a front perspective view of another embodiment of a water oxidation system 14, according to some embodiments, where FIGS. 19B, and 19C illustrate a partial bottom perspective and additional partial perspective view, respectively, thereof. For ease of reference, similar reference numbers for similar components included in the water oxidation system 12 may be used for water oxidation system 14. The water oxidation system 14 may be similar in function, and include similar components (which may have similar functions) as the water oxidation system 12, but may be arranged differently to provide a more compact configuration.

In the embodiment as shown in FIG. 19A, the system 14 may include a frame 90, an electrical system 80, a container 20, a control device 40, and a sensor 60. In some embodiments, all of the components and any necessary electronics are coupled to the frame 90. The system 14 may include a first generator 50a, a second generator 50b, or both, coupled to the frame 90. In some embodiments, the system includes a container 20 coupled to the frame 90. The container 20 may include a container inlet 1912 and a container outlet 1908 located opposite the container inlet 1912. In additional or alternative embodiments, the container 20 is fluidly coupled with the first generator 50a. The container 20 may be fluidly coupled to the first generator 50a by fluidly coupling a first gas tube 1910 to the container outlet 1908 and the first generator 50b. In some embodiments, the first generator 50a and the second generator 50b are arranged in series such that a gas may flow from the first generator 50a into the second generator 50b. The first generator 50a may be fluidly coupled to the second generator 50b by a second gas tube 1914. In additional or alternative embodiments, the system 14 includes a power supply 1918 electronically coupled and communicatively coupled with the electrical system 80. In some embodiments, the frame 90 is made of sheet metal.

The system 14 may include an input port 1926 and an output port 1922. The input port 1926, the output port 1922, or both, may be located at the bottom of the system 14. In additional or alternative embodiments, the system 14 includes an output tube 1930 configured to fluidly couple with the output port 1922, the control device 40, or both. The input port 1926 may be fluidly coupled with a flow sensor 1928 configured to obtain a measurement. In some embodiments, the flow sensor 1928 measurement is the flow rate of a fluid (e.g., liquid, such as water) flowing in the system via the input port 1926. The flow sensor 1928 may be configured to transmit the measurement to the electrical system 80. The flow sensor 1928 may be configured to obtain a flow rate measurement of a fluid flowing through the system 12 and may be further configured to transmit the flow rate measurement to the electrical system 80.

In some embodiments, the fluid flow path includes a first control valve 1906a (similar to the third control valve 1302c as shown and described above in FIGS. 13A-13C), a second control valve 1906b (similar to the second control valve 1302b as shown and described above in FIGS. 13A-13C), a third control valve 1906c (similar to the first control valve 1302a as shown and described above in FIGS. 13A-13C), or combinations thereof. The control device 40 may be configured to receive a sensor 60. In additional or alternative embodiments, the system 14 includes an output elbow 1902. The output elbow 1902 and the first control valve 1906a may be fluidly coupled by an elbow tube 1904. In some embodiments, the liquid and mixture flow path(s) of the system 14 is divided into three blocks. The first block may be sized and configured to at least partially contain the input port 1926 and the flow sensor 1928. The second block may be sized and configured to at least partially contain the first mixing device 30a, the second mixing device 30b, the second control valve 1906b and the third control valve 1906c. The third block may be sized and configured to contain the control device 40, the sensor 60, the first control valve 1906a, and fluidly couple with the output tube 1930 and the elbow tube 1904.

In the embodiment as shown in FIG. 19B, the system 14 may include a first mixing device 30a, a second mixing device 30b, and a y-valve 1936. In additional or alternative embodiments, the second generator 50b is fluidly coupled to a first mixing device 30a, a second mixing device 30b, or both. The system 14 may include a third gas tube 1916 configured to fluidly couple the second generator 50a with the y-valve 1936. In some embodiments, the system 14 includes a fourth gas tube 1934a configured to fluidly couple the y-valve 1936 with the first mixing device 30a. In additional or alternative embodiments, the system 14 includes a fifth gas tube 1934b configured to fluidly couple the y-valve 1936 with the second mixing device 30b. The y-valve 1936 may be configured to distribute a gas (which may be a gaseous mixture) from the second generator 50b to the first mixing device 30a or the second mixing device 30b. The system 14 may include a first power supply 1918a and a second power supply 1918b that may be electrically coupled, communicatively coupled, or both, with the electrical system 80. The first power supply 1918a, the second power supply 1918b, may be configured to transmit power to the first generator 50a, the second generator 50b, or both.

In the embodiment as shown in FIG. 19C, the system 14 may include a control device 40, a fluid inlet tube/system 1940, a flow sensor 1928, a first mixing device 30a, and a second mixing device 30b. In some embodiments, the system 14 includes a first flow path and a second flow path. The system 14 may include a plurality of flow paths (as described herein). When the system 14 is under the first flow path (as described herein), the internal components involved with the first flow path may include a fourth gas tube 1934a, a first mixing device 30a, a third control valve 1906c, a control device 40, an output tube 1930, and an output port 1922. When the system 14 is under the second flow path, the internal components involved with the second flow path may include a fifth gas tube 1934b, a second mixing device 30b, a second control valve 1906b, a control device 40, a first control valve 1906a, an elbow tube 1904, and an output elbow 1902. The beginning of both the first flow path and the second flow path may the same internal components.

The control device 40 may be configured to receive a sensor probe 1938 of sensor 60. In some embodiments, the control device 40 may be configured to at least partially receive a sensor housing 1932 of the sensor 60 when the sensor probe 1938 is inserted into the control device 40. As described herein, the control device 40 may include a fluid (e.g., mixture) chamber configured to receive the mixture from both the second and third control valves (1906b, 1906c), to thereby merge the first and second flow paths. The chamber in the control device 40 may be in fluid communication with the sensor probe 1938, and may flow via a tube through the probe into the sensor housing 1932. As described herein, the control device 40 may separate the first and second flow paths via output tube 1930, and/or elbow tube 1904.

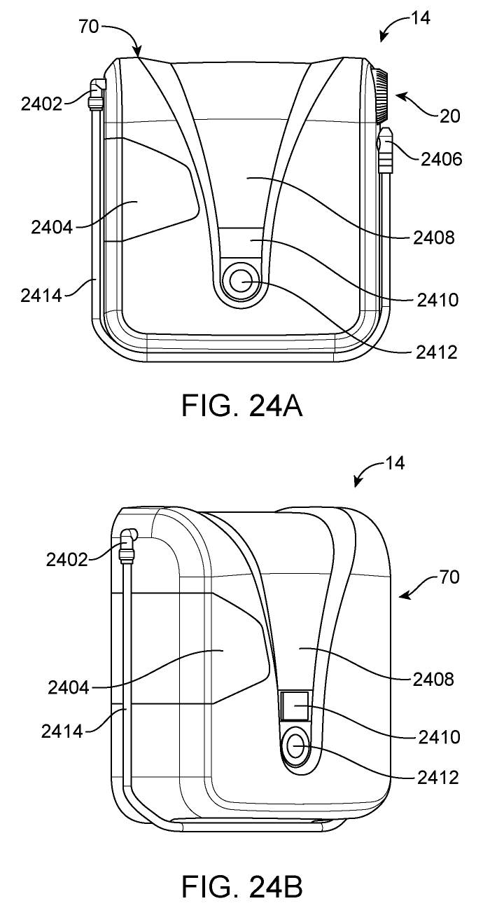

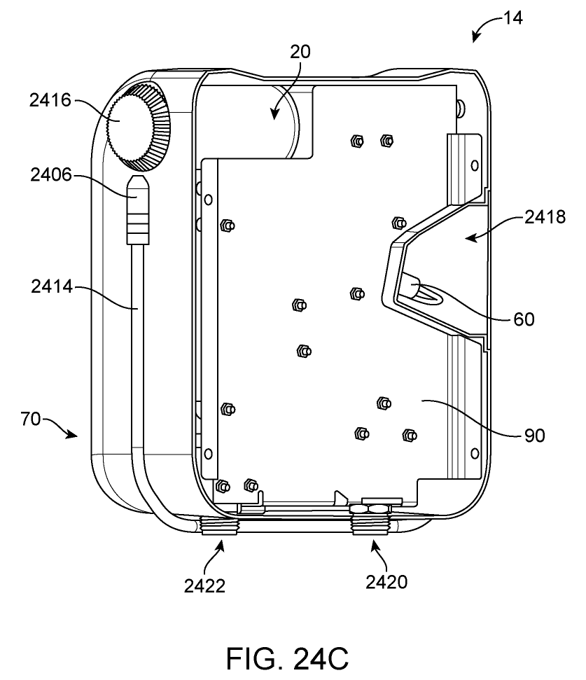

The system 14 may include a front cover (as shown and described below in FIGS. 24A-24C) configured to couple with the frame 90. The front cover, when coupled with the frame 90, may define an interior portion (as shown and described above in FIGS. 12A and 12B) where the components and any necessary electronics of the system 14 are at least substantially within the interior portion. Benefits of system 14, including only a front cover and a frame 90, may include a smaller form factor system 14. This small form factor of system 14 may allow a user to mount the system 14 in places a larger system (e.g., 12) may not be able to mount to. The front cover may include an access panel (as shown and described above in FIGS. 11A -F). Benefits of the front cover, including an access panel in the embodiment as shown in FIG. 19A may include easy access for a user to access the internal components of system 14.

In some embodiments, the electrical system 80 includes a display 1920 and an actuator 1924. The electrical system 80 may include a PCB (as shown and described above in FIGS. 13A-C) coupled to the front cover. The electrical system 80 may be communicatively coupled and electrically coupled with the flow sensor 1928. In additional or alternative embodiments, the electrical system 80 is coupled to the front cover.

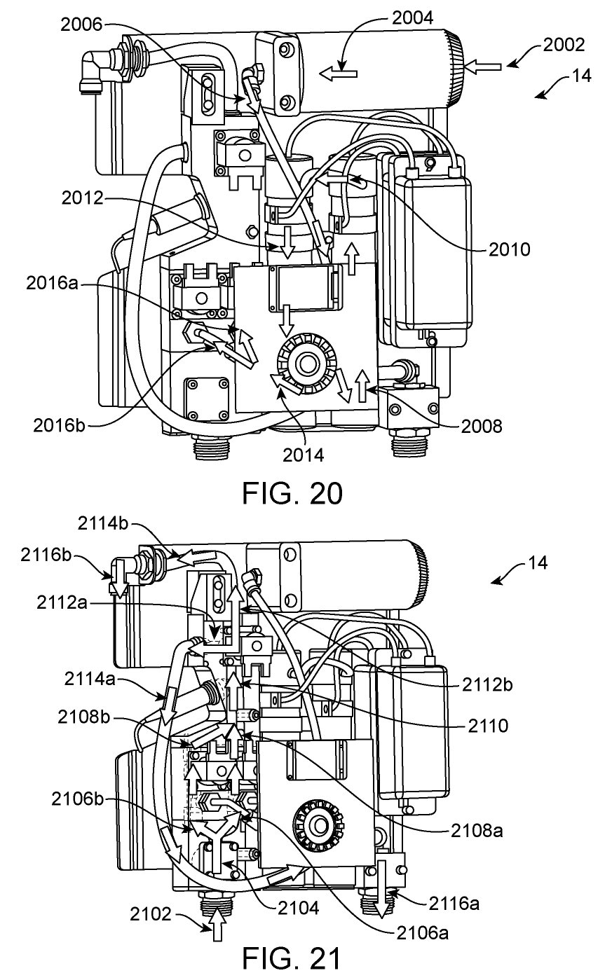

FIG. 20 illustrates a perspective view of a water oxidation system 14, according to some embodiments. Specifically, FIG. 20 depicts the flow of a gas through system 14 as described with respect to the components as shown and described in FIGS. 19A-C. In the embodiment as shown in FIG. 20, a gas may enter 2002 the system 14 at a container inlet 1912. The gas may then flow 2004 through a container 20 and into a container outlet 1908. The container outlet 1908 may be fluidly coupled to a first generator 50a by a first gas tube 1910. The gas may flow 2006 from the container outlet 1908, through a first gas tube 1910, and then may flow into a first generator 50a. The first generator 50a may be fluidly coupled with a second generator 50b, by a second gas tube 1914. After the gas flows 2008 through the first generator 50a, the gas may flow 2010 through the second gas tube 1914 and into the second generator 50b. In some embodiments, the second generator 50b is fluidly coupled with a y-valve 1936 by a third gas tube 1916 (which is hidden behind the electrical system 80 in this figure, but visible in FIG. 23B). The gas may flow 2012 through the second generator 50b. From the second generator 50b, the gas may flow 2014 through a third gas tube 1916 and into a y-valve 1936. The y-valve 1936 may be fluidly coupled to a first mixing device 30a by a fourth gas tube 1934a. In additional or alternative embodiments, the y-valve 1936 is fluidly coupled to a second mixing device 30b by a fifth gas tube 1934b. Dependent on the method of activation, the gas may then flow 2016a from the y-valve 1936 into a first mixing device 30a via the fourth gas tube 1934a or flow 2016b to the second mixing device 30b via the fifth gas tube 1934b. Arrows and their respective component numbers (for the arrows) are depictured in FIG. 20, for reference to show the path of a gas (e.g., gas, processed gas) through system 14 to the respective mixing device.

FIG. 21 illustrates a perspective view of a water oxidation system 14, according to some embodiments. Specifically, FIG. 21 depicts the flow of a liquid through system 14 as described with respect to the components as shown and described in FIGS. 19A-C. In the embodiment as shown in FIG. 21, the system 14 under either a first flow path or a second flow path, may begin with activation of the system (as described herein in system 12), where the input port 1926 intakes 2102 a fluid from an external fluid source. The fluid may then flow 2104 into a flow sensor 1928 and then further into the fluid inlet system 1940. The fluid may then flow 2106a into a first mixing device 30a or flow 2106b into a second mixing device 30b, depending on the method of activation (e.g., whether the system 14 is under the first flow path or the second flow path as described above in FIGS. 13A-C).

Under the first flow path, a first control valve 1906a and a second control valve 1906b may be in a closed state, preventing the flow 2108b of the liquid from passing through the second flow path, and where a third control valve 1906c may be in an open state, permitting the liquid to pass through 2108a. Liquid may flow 2106a from the fluid inlet system 1940 into the first mixing device 30a, where the liquid is mixed with a gas (e.g., gaseous mixture) to form a mixture. The mixture may then flow 2108a from the first mixing device 30a, though a third control valve 1906c, into 2110 a control device 40. From the control device 40, the fluid may then flow into 2112a an output tube 1930, to 2114a an output port 1922, and may then flow out 2116a of system 12.

Under the second flow path, the first control valve 1906a and a second control valve 1906b may be in the open state, and the third control valve 1906c may be in the closed state. Liquid may flow 2106b from the fluid inlet system 1940 into the second mixing device 30b, where the fluid is mixed with a gaseous mixture to form a mixture. The mixture then flows 2108b from the second mixing device 30a, past the second control valve 1906b, into 2110 the control device 40. From the control device 40, the fluid then flows into 2112b the first control valve 1906a, into an elbow tube 1904, to 2114b an output elbow 1902, and from the output elbow 1902, the fluid may flow out 2116b of the system 14.

As described herein, the mixing device 30a, 30b may be configured to generate a low-pressure zone (which may include pulling a vacuum or partial vacuum), so as to draw in the gas through the container. The mixing device 30a, 30b may be a venturi valve.

In some embodiments, the mixture under either the first flow path or the second flow path, when the mixture flows from either control valve, the mixture enters an inner cavity 1944 (e.g., compartment, chamber, etc.) of the control device 40 (as described herein), where the sensor probe 1938 of sensor 60 is located or in fluid communication with. The sensor 60 is configured to transmit a measurement to an electrical system 80. The electrical system 80 may be configured to receive a communication from the sensor 60. In some embodiments, the measurement the sensor 60 obtains is an ORP level. The electrical system 80 may be configured to display the ORP level measurement obtained by the sensor on a display 1920. Arrows and their respective component numbers (for the arrows) are depictured in FIG. 21, for reference to show the path of a fluid (e.g., liquid, mixture [treated liquid], water) through system 14.

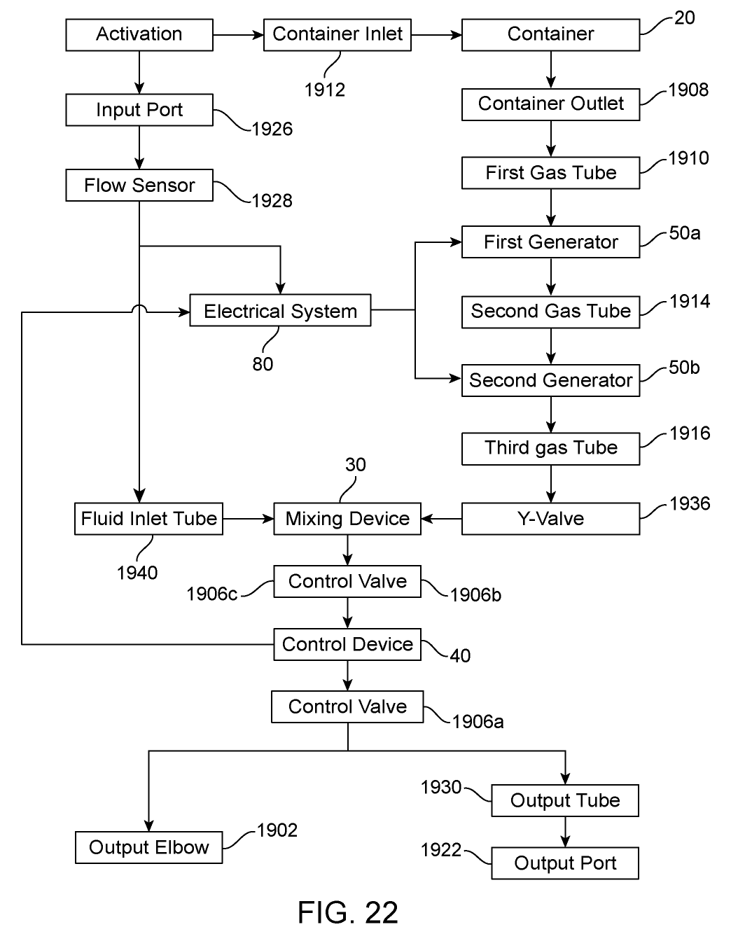

FIG. 22 illustrates a block diagram of a water oxidation system 14 depicting the flow of both a liquid and a gas, according to some embodiments. As shown in FIG. 22, the system 14 may be under a first flow path or a second flow path. Both the first flow path and the second flow path, when a liquid is flowing through the system 14, may involve certain similar components (or at least types of components), but may have different outputs. This may be for example different flow rates. In some cases, this may be different ORP levels.

The system 14 may include an electrical system 80. In some embodiments, the electrical system 80 includes an actuator 1924 and a display 1920. The system 14 may be under the first flow path generally and converted (i.e., switch, toggled, swapped, etc.) to the second flow path when the actuator 1924 is activated. The system 14 may be configured to be under the first flow path when the actuator 1924 is not activated. The system 14 may be configured to be under the second flow path when the actuator 1924 is activated. In some embodiments, the first flow path outputs the liquid (e.g., ozonated water) to an external connection, as described herein (e.g., a laundry or washing machine, dishwasher, etc.). In additional or alternative embodiments, the second flow path outputs to a fill station (which may be a hose outlet, a bottle fill, etc.).

The electrical system 80 may be configured to set the flow path of system 14. In some embodiments, the electrical system 80 sets the flow path of system 14 to the first flow path, when the actuator 1924 is not activated and sets the system 14 to the second flow path, when the actuator 1924 is activated. For example, the electrical system 80 may be configured to transition the open or closed position of any one or more of control valves 1906a, 1906b, and 1906c. In additional or alternative embodiments, the electrical system 80 includes a plurality of LEDs 1942 configured to emit a color, a pattern, or both. In some embodiments, the LEDs 1942 emit a blue color when the system 14 is activated and a fluid is flowing through the system 14.

When the system 14 is under either the first flow path or the second flow path, both flow paths may begin with activation (of the system, as described herein) where an input port 1926, receives a fluid (e.g., water), from an external water source. The system 14 may receive the fluid by a fluid inlet system 1940. In some embodiments, the input port 1926 is fluidly coupled with a flow sensor 1928 configured to obtain a flow rate measurement of the water. The flow sensor 1928 may be configured to assign the flow rate measurement a value between 0-100 and may be further configured to communicate the flow rate measurement to the electrical system 80. In some embodiments, the electrical system 80 is configured to display the flow rate measurement on a display 1920. This may also be applicable with flow sensor 1330 for system 12.

In additional or alternative embodiments, the electrical system 80 is configured to set a threshold flow rate percentage. The set threshold flow rate percentage may be a specific flow rate used to indicate a sufficient flow rate of a liquid is flowing through the system 14 for operation. In some embodiments, the threshold flow rate percentage is a max threshold flow rate percentage.

The flow sensor 1928 may be fluidly coupled with the fluid inlet system 1940. In some embodiments, the fluid inlet system 1940 is fluidly coupled with a first mixing device 30a, and a second mixing device 30b. From the flow sensor 1928, the water may then flow into the first mixing device 30a if the system 14 is under the first flow path and into the second mixing device 30b if the system 14 is under the second flow path. In some embodiments, the fluid inlet system 1940 includes a fluid inlet tube.

Concurrently as the input port 1926 receives water from the external water source, a container 20 may begin to intake air (O2) through a container inlet 1912. The air may then flow from the container inlet 1912, through the container 20, and may then flow to a container outlet 1908. As the air flows through the container 20 and to the container outlet 1908, the air may be dehydrated and moisture may be removed.

The container outlet 1908 may be fluidly coupled to a first generator 50a by a first gas tube 1910 that may be configured to facilitate the transport of air from the container 20 to the first generator 50a. The air may then flow through the first generator 50a, where the air may be excited and form ozone molecules (O3), creating a gaseous mixture of combined air and ozone molecules. The first generator 50a may be fluidly coupled to a second generator 50b where the first generator 50a and the second generator 50b are in a series configuration. The first generator 50a and the second generator 50b may be fluidly coupled by a second gas tube 1914 sized and configured to facilitate the flow of the gaseous mixture from the first generator 50a to the second generator 50b. The gaseous mixture then flows through the second generator 50b where the resulting gaseous mixture includes more ozone than from the first generator 50a. In some cases, the oxygen in the air is entirely or almost entirely converted to ozone. The air may then flow from the second generator 50b to a y-valve 1936 through a third gas tube 1916 that is sized and configured to facilitate the flow of the gaseous mixture from the second generator 50b to the y-valve 1936. When the system 14 is under the first flow path, the gaseous mixture may flow from the y-valve 1936 to the first mixing device 30a through a fourth gas tube 1934a (e.g., the mixing device, such as a venturi valve, may pull the gaseous mixture via the fluid flow rate therethrough). When the system 14 is under the second flow path, the gaseous mixture may flow from the y-valve 1936 to the second mixing device 30b through a fifth gas tube 1934b.

Concurrently, as the water enters into the mixing device 30a, 30b, the gaseous mixture enters the mixing device 30a, 30b, combing and/or mixing with the water to form an ozonated-water mixture (mixture). The mixture then flows past a respective control valve (e.g., if system 14 is under the first flow path, the water may flow past the third control valve 1906c and if the system 14 is under the second flow path, the water may flow past the second control valve 1906b), and into a common inner cavity 1944 of the control device 40. The control device may include a sensor 60 configured to obtain a measurement of the mixture. In additional or alternative embodiments, the sensor includes a sensor probe 1938 configured to obtain the measurement of the mixture. The sensor 60 may be configured to communicate the measurement of the mixture to the electrical system 80. In some embodiments, the sensor 60 obtains an ORP level measurement of the mixture and/or is configured to communicate the ORP level measurement with the electrical system 80. In additional or alternative embodiments, the inner cavity 1944 of the control device 40 is configured to receive and/or be in fluid communication with the sensor probe 1938. The sensor 60 may be configured to obtain the measurement concurrently as the mixture is flowing through the control device 40 and to its respective output.

Dependent upon the flow path, from the inner cavity 1944 of the control device 40, the mixture may then proceed to its respective output points. When the system 14 is under the first flow path, a first control valve 1906a is in a closed state preventing the flow of the mixture through it. Thus, the mixture may flow from the inner cavity 1944 of the control device 40 through an output tube 1930 fluidly coupled with the inner cavity 1944 of the control device 40, and to an output port 1922. The output tube 1930 may be configured to facilitate the flow of the mixture from the inner cavity 1944 of the control device 40 to the output port 1922. From the output port 1922, the mixture may then flow into an external component (e.g., washing machine, dishwasher, etc.) that may be fluidly coupled with the output port 1922. As used herein, the term external component may be used interchangeably with the term external connection.

When the system 14 is under the second flow path, the mixture may flow from the inner cavity 1944 of the control device 40 past the first control valve 1906a in an open state. The first control valve 1906a may be fluidly coupled with an output elbow 1902 by an elbow tube 1904 that may be sized and configured to facilitate the flow of the mixture from the inner first control valve 1906a and to the output elbow 1902. From the output elbow 1902, the mixture may flow to its end destination (e.g., a bottle, an external connection which may include a washing machine, a hose, etc.).

FIG. 23A illustrates afront view of a water oxidation system 14, according to some embodiments, and FIG. 23B illustrates a rear view thereof. FIGS. 23A-23B depict the system 14, with and without certain components shown so as to better depict other connections (e.g., y-valve between second generator 50b and mixing device(s)). FIGS. 23A-23B depict system 14 similar to FIGS. 19-21. Although the FIGS. 23A-23B may contain different component numbers that are used to refer to specific components (as compared with FIGS. 19-21), the components in FIGS. 23A-23B may have similar purposes and/or functionalities as the components in FIGS. 19-21, and/or may be the same all together. In the embodiment as shown in FIG. 23A, the system 14 may include a frame 90, a container 20, a control device 40, a sensor 60, a first generator 50a, a second generator 50b, and a partial cover 2320.The system 14 may include an installation device 2306 (or may be herein referred to as an “assembly fixture”). The installation device 2306 may include an installation coupler 2304 configured to securely couple the installation device 2306 to the frame 90. Benefits of the installation device 2306 and the installation coupler 2304 may include facilitating easy mounting of the system 14 to an external surface, easy maintenance by a user, and/or easy removal by the user. The installation device 2306 may be configured to facilitate a user assembling the system 14.

System 14 may include an electrical system 80. The electrical system 80 may be coupled to a front cover (as shown and described below in FIGS. 24A-24C). In some embodiments, the electrical system 80 includes a display 2312 located on the front cover and an actuator 2316 located on the front cover. The electrical system 80 may include a PCB (as shown and described in FIGS. 13A-C), configured to couple with the partial cover 2320. In some embodiments, the electrical system 80 includes one or more LEDs 2308 (as described herein). The sensor 60 may be electronically coupled and communicatively coupled with the electrical system 80.

In the embodiment as shown in FIG. 23B the system 14 may include a first mixing device 30a, a second mixing device 30b, and a flow sensor 2336. In additional or alternative embodiments, the system 14 includes a y-valve 2332 configured to distribute a gaseous mixture to either the first mixing device 30a through a fourth gas tube 2334a or the second mixing device 30b through a fifth gas tube 2334b. The system 14 may include a third gas tube 2330 configured to fluidly couple the second generator 50b with the y-valve 2332.

In some embodiments, the container 20 includes a container inlet 2324 and a container outlet 2340 located opposite the container inlet 2324. The container inlet 2324 may be configured to intake a gas when system 14 is activated. In additional or alternative embodiments, the system 14 includes a first gas tube 2326 configured to fluidly couple the container outlet 2340 with the first generator 50a. In some embodiments, the container outlet 2340 is configured to allow a gas that has passed through the container 20 to the first generator 50a through the first gas tube 2326. The system 14 may include a second gas tube 2328 configured to fluidly couple the first generator 50a to the second generator 50b and facilitate the flow of a gas or gaseous mixture from the first generator 50a to the second generator 50b.

In additional or alternative embodiments, the system 14 includes an input port 2318 and an output port 2314. The output port 2314 may be configured to fluidly couple with an output tube (as shown and described above in FIGS. 19A and 19B). The input port 2318 may fluidly couple with a flow sensor 2336. The flow sensor 2336 may be electronically coupled and communicatively coupled with the electrical system 80. In some embodiments, the flow sensor 2336 is fluidly coupled with the first mixing device 30a and the second mixing device 30b.

The system 14 may include a first control valve 2338a that may be fluidly coupled with the first mixing device 30a. The first control valve 2338a may be fluidly coupled with the control device 40, and electronically coupled and communicatively coupled with the electrical system 80. In some embodiments, the system 14 includes a second control valve 2338b fluidly coupled with the second mixing device 30b. The second control valve 2338b may be fluidly coupled with the control device 40, electronically coupled, and communicatively coupled with the electrical system 80.

In additional or alternative embodiments, the first control valve 2338a and the second control valve 2338b are fluidly coupled with the control device 40. System 14 may include a third control valve 2338c fluidly coupled with the control device 40 and the elbow tube 2322. In some embodiments, the control device 40 is configured to fluidly couple with an output tube (as shown and described above in FIGS. 19A and 19B). The system 14 may include an output elbow 2302 fluidly coupled with the elbow tube 2322. In additional or alternative embodiments, the system 14 includes a nozzle 2310. The nozzle 2310 may be configured to magnetically couple to the magnet (as shown and described in FIGS. 11A-F). In some embodiments, the nozzle 2310 is fluidly coupled to the output elbow 2302. The nozzle 2310 may be fluidly coupled to the output elbow 2302 by a nozzle hose. The nozzle 2310 may be similarly used for system 10 or 12.

FIG. 24A illustrates a front view of a water oxidation system 12, according to some embodiments, and FIGS. 24B and 24C illustrates a front perspective and rear perspective view thereof. FIGS. 24A-24B depict a front cover of the system 14 (or as depicted in FIGS. 19A-23B). Additionally, FIGS. 24A-24B may depict a housing configuration and/or depiction for system 14 of FIGS. 19A-23B.

In the embodiment as shown in FIG. 24A, the system 12 may include a housing 70, a container 20, and an actuator 2412. In some embodiments, the system 12 includes a display 2410 located on the housing 70. The housing 70 may be a front cover. In additional or alternative embodiments, the system 14 includes a first access panel 2404. The system 14 may include a second access panel 2408. In some embodiments, the system 14 includes an output elbow 2402. In some embodiments, the system 14 includes a fill tube 2414. The system 14 may include a nozzle 2406. The fill tube 2414 may be configured to couple the output elbow 2402 to the nozzle 2406. In some embodiments, the fill tube 2414 is configured to fluidly couple with the output elbow 2402, the nozzle 2406, or both. The system may include an actuator 2412 located at least partially on the housing 70.

In the embodiment as shown in FIG. 24B, the system 12 may include a housing 70, an output elbow 2402 fluidly coupled with a fill tube 2414, a first access panel 2404 located at least partially on the housing 70, a second access panel 2408 located at least partially on the housing, a display 2410, and an actuator 2412.

In the embodiment as shown in FIG. 24C, the system 14 may include a housing 70 and a frame 90. In some embodiments, the housing 70 is a front cover. The housing 70 may be configured to couple with the frame 90. When the housing 70 is coupled with the frame 90, the housing 70 and the frame 90 may define an interior portion 2418. The system 14 may include a container 20 located at least partially within the interior portion 2418 and may be coupled to the frame 90, the housing 70, or both. In some embodiments, the container 20 includes a cap 2416. The cap 2416 may be a container cap. The cap 2416 may include a pattern at least partially on a surface of the cap 2416. The system 14 may include a sensor 60 located at least partially within the interior portion 2418. In additional or alternative embodiments, the system 14 includes an output port 2420. The output port 2420 may be configured to dispense a mixture. In some embodiments, the system 14 includes an input port 2422. The input port 2422 may be configured to receive a fluid. The input port 2422 may be configured to receive a fluid from an external fluid source or an external component.

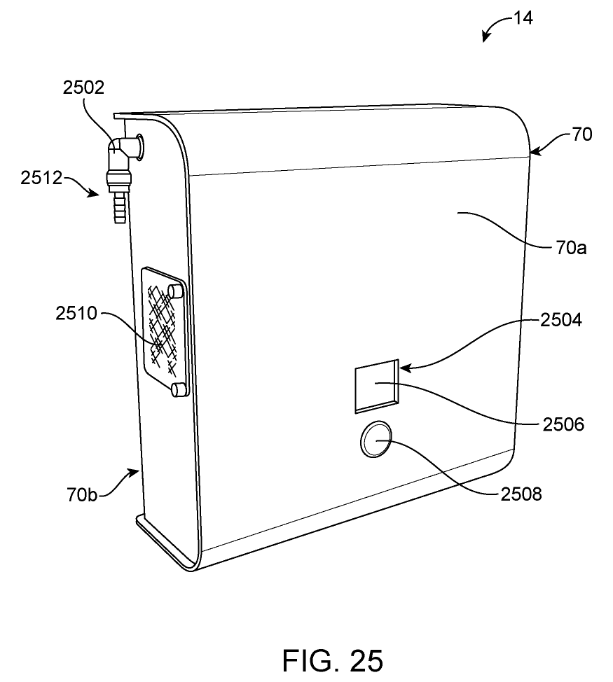

FIG. 25 illustrates a perspective view of another water oxidation system 14. FIG. 25 depicts a system 14 described herein having another type of a housing 70 and/or a cover, where a front cover 70a is depicted. The cover may have a cutout (which may be similar or not similar to the front cover of FIGS. 11A-11C, 23A-23B, and/or 24A-24C), for the display 2506, and/or the actuator 2508. FIG. 25 further depicts the front cover 70a, can be coupled with a side housing portion, which may be separate or separable from the rear cover 70b (FIG. 25 depicts 70b pointing to a back side of the side portion). In other cases, the front cover 70a, is coupled to a base housing portion that includes two sides and a rear portion, such that the front cover 70a acts as a removable lid, or cover, about the base housing. These variations may also be represented and applicable to any housing and/or cover depicted herein (including FIGS. 11A-11C, 23A-23B, and/or 24A-24C). The housing may have an access port or the same 2510 on a side portion (which may be part of the rear cover 70b or a side portion that is separate from the rear cover) interfacing with an interior portion.

For any cover or housing described herein, for any system 10, 12, 14, said cover or housing may be made from injection molded plastic, bent sheet metal (aluminum, stainless, or steel) and/or formed sheet metal. Each housing described herein may have a form of a front cover, rear cover, and/or intermediate chassis (e.g., a side portion, or other part of the housing). In some embodiments, the front cover 70a, the rear cover 70b, and/or intermediate chassis (which may be located or at least partially located between one or both sides of the front and rear cover, or may not be provided at all when the first and second covers couple together directly) may be provided for a housing for the components of any system 10, 12, 14 described herein.

In the embodiment as shown in FIG. 25, the system 14 may include a housing 70. The housing may include a front cover 70a, and a rear cover 70b. In some embodiments, the housing 70 includes an access panel 2510 (as described herein). The access panel 2510 may be located on a side of the housing 70. The access panel 2510 as depicted may be used to access an internal component of the system, such as the sensor 60 and/or probe. The housing 70 may include a similar access panel 2510 on the other side of the housing (e.g., opposite side of where 2510 is depicted in FIG. 25), which may be used to access other components of the system, such as for example the container (e.g., to access the desiccant). A display recess 2504 may be located at least partially on the housing 70. In some embodiments, the display recess 2504 is located at least partially on the front cover 70a. The display recess 2504, may be sized and/or configured to receive and/or securely couple with a display 2506 (as described herein). The system 14 may include an actuator 2508 located at least partially on the housing 70. The actuator 2508 may be located at least partially on the front cover 70a. In some embodiments, the system 14 includes a fill system 2512 (as described herein, which may include a container, a bucket, or simply an ability to receive the treated water and/or fill an enclosure). The system 14 may include an output elbow 2502. The fill system 2512 may include the output elbow 2502. Although different component numbers are used herein, particularly in certain figures, the components for system 14 may be the same across FIGS. 19-25.

### Numbered Embodiments

The following include different embodiments for a system described herein.

Embodiment 1: A system comprising: a first inlet configured to receive a liquid from a first external source; a second inlet configured to receive a gas from a second external source; a generator fluidly coupled with the second inlet and configured to process the gas so as to generate a processed gas; a first mixing device disposed along a first flow path, the first mixing device configured to mix the liquid and the processed gas, so as to produce a treated liquid, the first mixing device configured to output the treated liquid at a first flow rate; a second mixing device disposed along a second flow path, the second mixing device configured to mix the liquid and the processed gas, so as to produce the treated liquid, the second mixing device configured to output the treated liquid at a second flow rate that is different than the first flow rate, wherein at least a portion of the first flow path is parallel with at least a portion of the second flow path; an actuator configured to toggle between a first flow path operation and a second flow path operation, wherein under the first flow path operation, the liquid and the processed gas pass through the first mixing device, wherein under the second flow path operation, the liquid and the processed gas pass through the second mixing device; and a first outlet for dispensing the treated liquid to a first external location.

Embodiment 2: The system of Embodiment 1, wherein the first flow path comprises a first control valve, and wherein the second flow path comprises a second control valve, such that toggling between the first flow path operation and the second flow path operation comprises adjusting an open position of the first control valve, the second control valve, or both.

Embodiment 3: The system of Embodiment 2, wherein adjusting the open position comprises i) transitioning the first control valve, the second control valve, or both, to an open position to allow the liquid or the treated liquid to pass therethrough, ii) transitioning the first control valve, the second control valve, or both, to a closed position to prevent or reduce an amount of the liquid or the treated liquid to pass therethrough, or iii) both.

Embodiment 4: The system of Embodiment 2 or 3, wherein the actuator is communicatively coupled with the first control valve, the second control valve, or both, so as to enable adjusting the open position of the first control valve, the second control valve, or both.

Embodiment 5: The system of any one of Embodiments 1-4, wherein the treated gas produced by the first mixing device is molecularly different from the treated gas produced by the second mixing device.

Embodiment 6: The system of any one of Embodiments 1-4, wherein the treated gas produced by the first mixing device is molecularly the same or substantially the same as the treated gas produced by the second mixing device

Embodiment 7: The system of any one of Embodiments 1-6, wherein the first external source is configured to provide the liquid in a pressurized state, thereby providing the motive force of the liquid to flow through the system when the external source has a pressure higher than a pressure of the first external location.

Embodiment 8: The system of Embodiment 7, wherein the gas is air and the second external source a surrounding environment of the system.

Embodiment 9: The system of Embodiment 8, wherein the liquid flowing through the first mixing device, the second mixing device, or both, creates a motive force for the gas to flow through the system.

Embodiment 10: The system of Embodiment 9, wherein the first mixing device, the second mixing device, or both, comprises an orifice that increases a velocity of the liquid, thereby creating a low pressure zone within the first mixing device, the second mixing device, or both, such that a pressure differential between the second external source and the low pressure zone creates the motive force for the gas.

Embodiment 11: The system of Embodiment 10, wherein the orifice of the first mixing device, the second mixing device, or both, comprises a restriction orifice configured to provide a constricted cross-sectional area relative to an upstream and downstream portion of the first flow path, the second flow path, or both.

Embodiment 12: The system of any one of Embodiments 9-11, wherein the first mixing device, the second mixing device, or both, comprises a venturi injector, a venturi valve, a venturi orifice, or any combination thereof.

Embodiment 13: The system of any one of Embodiments 10-12, wherein the first mixing device, the second mixing device, or both, comprises a gas suction inlet fluidly coupling the generator to the liquid flowing in the system, the gas suction inlet disposed about the low pressure zone.

Embodiment 14: The system of Embodiment 12 or 13, wherein the first mixing device, the second mixing device, or both, comprises a tee connection, wherein the gas suction inlet is oriented in a direction that is perpendicular or substantially perpendicular to the liquid flow in the tee connection.

Embodiment 15: The system of Embodiment 14, wherein for the first mixing device, the second mixing device, or both, the orifice is disposed upstream of the tee connection.

Embodiment 16: The system of Embodiment 14 or 15, wherein the orifice and the tee connection of the first mixing device, the second mixing device, or both, are i) a singular component, or ii) separable components coupled together.

Embodiment 17: The system of any one of Embodiments 10-16, wherein the orifice of the first mixing device comprises a cross-sectional area that is from about 0.5 to about 5.0 times in size compared to a cross-sectional area of the orifice of the second mixing device, such that the first flow rate is larger than the second flow rate according to a cross-sectional area size proportional increase in volumetric flow.

Embodiment 18: The system of any one of Embodiments 10-16, wherein the orifice of the first mixing device comprises a cross-sectional area that is from about 1.0 to about 3.0 times in size compared to a cross-sectional area of the orifice of the second mixing device, such that the first flow rate is larger than the second flow rate according to a cross-sectional area size proportional increase in volumetric flow.

Embodiment 19: The system of any one of Embodiments 10-16, wherein the orifice of the first mixing device comprises a cross-sectional area that is from about 1.5 to about 2.0 times in size compared to a cross-sectional area of the orifice of the second mixing device, such that the first flow rate is larger than the second flow rate according to a cross-sectional area size proportional increase in volumetric flow.

Embodiment 20: The system of any one of Embodiments 1-19, further comprising a control device in fluidic communication with a treated liquid sensor, the treated liquid sensor configured to detect a property of the treated liquid.

Embodiment 21: The system of Embodiment 20, wherein the property of the treated liquid comprises an oxidation-reduction potential.

Embodiment 22: The system of Embodiment 20 or 21, wherein the treated liquid sensor is in communication with a display panel, an LED module, or both, wherein the treated liquid sensor is configured to indicate whether the property of the treated liquid is above a minimum threshold.

Embodiment 23: The system of any one of Embodiments 20-22, wherein the control device comprises a chamber configured to receive the treated liquid from the first flow path, the second flow path, or both.

Embodiment 24: The system of Embodiment 23, wherein the treated liquid sensor is configured to be i) exposed in the chamber, ii) in fluidic communication with the chamber, or iii) both.

Embodiment 25: The system of any one of Embodiments 20-24, further comprising an output tube fluidly coupling the control device with the first outlet.

Embodiment 26: The system of Embodiment 25, wherein the first flow path is a first portion of the first flow path, and wherein the output tube is a second portion of the first flow path.

Embodiment 27: The system of any one of Embodiments 20-26, further comprising a second outlet for dispensing the treated liquid to a second external location.

Embodiment 28: The system of Embodiment 27, further comprising an elbow tube fluidly coupling the control device with the second outlet.

Embodiment 29: The system of Embodiment 28, wherein the second flow path is a first portion of the second flow path, and wherein the elbow tube is a part of a second portion of the second flow path.

Embodiment 30: The system of Embodiment 29, wherein the second portion of the second flow path further comprises a third control valve, such that toggling between the first flow path operation and the second flow path operation comprises adjusting an open position of the first control valve, the second control valve, the third control valve, or any combination thereof.

Embodiment 31: The system of Embodiment 30, wherein the first flow path operation comprises i) the first control valve to be in the open position to allow the liquid or the treated liquid to pass therethrough, and ii) the second control valve and the third control valve to be in the closed position to prevent or reduce an amount of the liquid or the treated liquid to pass therethrough.

Embodiment 32: The system of Embodiment 30 or 31, wherein the second flow path operation comprises i) the first control valve to be in the closed position to prevent or reduce the liquid or the treated liquid to pass therethrough, and ii) the second control valve and the third control valve to be in the open position to allow the liquid or the treated liquid to pass therethrough.

Embodiment 33: The system of any one of Embodiments 30-32, wherein the actuator is communicatively coupled with the first control valve, the second control valve, the third control valve, or any combination thereof, so as to enable adjusting the open position of the first control valve, the second control valve, the third control valve, or any combination thereof.

Embodiment 34: The system of any one of Embodiments 1-33, wherein the first external location comprises a washing machine, a sink unit, a dishwasher, a hose, or any combination thereof.

Embodiment 35: The system of any one of Embodiments 27-34, wherein the second outlet comprises a hose or nozzle.

Embodiment 36: The system of Embodiment 35, further comprising a magnet configured to couple with the hose or nozzle.

Embodiment 37: The system of any one of Embodiments 27-36, wherein the second external location comprises a bucket, bottle, a container, or any combination thereof.

Embodiment 38: The system of any one of Embodiments 1-37, wherein the generator comprises a first generator and a second generator fluidly coupled with the first generator, wherein the first generator and the second generator are coupled in series, such that the gas is configured to flow from the second inlet to the first generator to the second generator and then to one or both of the first mixing device and the second mixing device.

Embodiment 39: The system of any one of Embodiments 1-38, further comprising a gas container fluidly coupled with the second inlet, the container configured to dry or at least partially dry the gas.

Embodiment 40: The system of Embodiment 39, wherein the gas container comprises desiccant material.

Embodiment 41: The system of any one of Embodiments 1-40, further comprising a y-valve configured to divert a flow of the processed gas from the generator to the first mixing device, the second mixing device, or both.

Embodiment 42: The system of any one of Embodiments 1-41, further comprising a flow sensor configured to measure a flow rate of the liquid passing through the first inlet.

Embodiment 43: The system of Embodiment 42, wherein the flow sensor is communicatively coupled with a display, such that the display is configured to display the measured flow rate.

Embodiment 44: The system of any one of Embodiments 1-43, further comprising a front cover and a rear cover configured to couple to the front cover, so as to define an interior portion, such that the front cover and the rear cover coupled together provide a housing for one or more of the first mixing device, the second mixing device, and the generator.

Embodiment 45: The system of any one of Embodiments 1-44, further comprising an electrical system configured to provide electrical power to the actuator, the first control valve, the second control valve, the third control valve, the generator, the flow sensor, the display, the treated liquid sensor, or any combination thereof.

Embodiment 46: The system of any one of Embodiments 1-45, wherein the generator is configured to process the gas by exciting the gas.

Embodiment 47: The system of Embodiment 46, wherein exciting the gas is via applying electrical energy, UV light, or both, to the gas.

Embodiment 48: The system of Embodiment 46 or 47, wherein the gas comprises oxygen, wherein exciting the gas results in at least some of the oxygen to be converted into ozone, such that the processed gas comprises ozone.

Embodiment 49: The system of Embodiment 48, wherein the liquid comprises water, such that the treated liquid comprises ozonated water.

Embodiment 50: The system of any one of Embodiments 1-49, further comprising one or more additional flow paths, and optionally wherein each additional flow path corresponds to an additional outlet for dispensing the treated liquid.

Embodiment 51: A system comprising a first inlet configured to receive a liquid from a first external source; a second inlet configured to receive a gas from a second external source; a generator fluidly coupled with the second inlet and configured to process the gas so as to generate a processed gas; a mixing device configured to mix the liquid and the processed gas, so as to produce a treated liquid; and a first outlet for dispensing the treated liquid to a first external location.

Embodiment 52: The system of Embodiment 51, further comprising a first flow path configured to deliver the treated liquid to the first outlet, and a second flow path configured to deliver the treated liquid to a second outlet for dispensing the treated liquid to a second external location.

Embodiment 53: The system of Embodiment 51 or 52, wherein the first external location comprises a washing machine, a sink unit, a hose, or any combination thereof, and the second external location comprises a bottle, a bucket, a container, or any combination thereof.

Embodiment 54: The system of Embodiment 52 or 53, further comprising a control device configured to divert a flow of the treated liquid to the first flow path, the second flow path, or both.

Embodiment 55: The system of any one of Embodiments 52-54, further comprising an actuator configured to actuate the control device so as to divert the flow through only the first flow path, through only the second flow path, or through both the first and second flow paths.

Embodiment 56: The system of any one of Embodiments 51-55, wherein the first external source is configured to provide the liquid in a pressurized state, thereby providing a motive force for the liquid to flow through the system.

Embodiment 57: The system of Embodiment 56, wherein the second external source is a surrounding environment of the system.

Embodiment 58: The system of Embodiment 57, wherein the liquid flowing through the mixing device creates a motive force for the gas to flow through the system.

Embodiment 59: The system of Embodiment 58, wherein the mixing device comprises an orifice that increases a velocity of the liquid, thereby creating a low pressure zone within the mixing device, such that a pressure differential between the second external source and the low pressure zone creates the motive force for the gas.

Embodiment 60: The system of Embodiment 59, wherein the orifice comprises a restriction orifice configured to provide a constricted cross-sectional area relative to an upstream and downstream portion of a flow path.

Embodiment 61: The system of any one of Embodiments 58-60, wherein the mixing device comprises a venturi injector, a venturi valve, a venturi orifice, or any combination thereof.

Embodiment 62: The system of 61, wherein the mixing device comprises a tee connection, wherein the tee connection is configured to receive the processed gas in a direction that is perpendicular or substantially perpendicular to the liquid flow in the tee connection.

Embodiment 63: The system of Embodiment 62, wherein the orifice and the tee connection of the mixing device are i) a singular component, or ii) separable components coupled together.

Embodiment 64: The system of any one of Embodiments 51-63, further comprising a treated liquid sensor in fluid communication with the treated liquid flow, the treated liquid sensor configured to detect a property of the treated liquid.

Embodiment 65: The system of Embodiment 64, wherein the property of the treated liquid comprises an oxidation-reduction potential.

Embodiment 66: The system of any one of Embodiments 51-65, wherein the generator comprises a first generator and a second generator fluidly coupled with the first generator, wherein the first generator and the second generator are coupled in series, such that the gas is configured to flow from the second inlet to the first generator to the second generator and then to the mixing device.

Embodiment 67: The system of any one of Embodiments 51-66, further comprising a gas container fluidly coupled with the second inlet, the container configured to dry or at least partially dry the gas.

Embodiment 68: The system of Embodiment 67, wherein the gas container comprises desiccant material.

Embodiment 69: The system of any one of Embodiments 1-68, wherein the generator is configured to process the gas by exciting the gas.

Embodiment 70: The system of Embodiment 69, wherein exciting the gas is via applying electrical energy, UV light, or both, to the gas.

Embodiment 71: The system of Embodiment 69 or 70, wherein the gas comprises oxygen, wherein exciting the gas results in at least some of the oxygen to be converted into ozone, such that the processed gas comprises ozone.

Embodiment 72: The system of Embodiment 71, wherein the liquid comprises water, such that the treated liquid comprises ozonated water.

Embodiment 73: A method comprising: providing a system of any one of Embodiments 1-72; and activating the system, wherein activating the system comprises i) allowing for the first inlet to be in fluid communication with the first external source, wherein the first external source is pressurized, ii) providing an open or at least partially open path to the first external location, the second external location, or both, so as to create a pressure differential between the first external source and the first external location, the second external location, or both, thereby providing a motive force for the liquid to flow through the system; wherein the liquid flowing through the system creates the motive force for the gas to flow through the system, such that the gas is processed by the generator, and such that the processed gas is mixed with the liquid to create the treated liquid.

Embodiment 74: The method of Embodiment 73, further comprising actuating the actuator, thereby diverting the liquid, the gas, and the treated liquid from flowing through the first flow path to the second flow path.

Some of the components listed herein use the same number from figure to figure. It should be appreciated these components use the same numbers solely for ease of reference and to facilitate comprehension for the reader. While these components may use the same numbers, differences may be present in these components as illustrated in the various figures in which they appear and as described in the specification herein.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” refers to less than or equal to +/−1%, +/−2%, +/−3%, +/−4%, +/−5%, +/−6%, +/−7%, +/−8%, +/−9%, +/−10%, +/−11%, +/−12%, +/−14%, or +/−15% variation. As a non-limiting example, substantially parallel represents a range of −1 to 1 degree difference, −5 to 5 degree difference, or −15 degrees to 15 degrees of difference from being parallel, depending on the embodiments.

We Claim:

1. A system comprising:
a first inlet configured to receive a liquid from a first external source;
a second inlet configured to receive a gas from a second external source;
a generator fluidly coupled with the second inlet and configured to process the gas so as to generate a processed gas;
a first mixing device disposed along a first flow path, the first mixing device configured to mix the liquid and the processed gas, so as to produce a treated liquid, the first mixing device configured to output the treated liquid at a first flow rate;
a second mixing device disposed along a second flow path, the second mixing device configured to mix the liquid and the processed gas, so as to produce the treated liquid, the second mixing device configured to output the treated liquid at a second flow rate that is different than the first flow rate, wherein at least a portion of the first flow path is parallel with at least a portion of the second flow path;
an actuator configured to toggle between a first flow path operation and a second flow path operation, wherein under the first flow path operation, the liquid and the processed gas pass through the first mixing device, wherein under the second flow path operation, the liquid and the processed gas pass through the second mixing device; and
a first outlet for dispensing the treated liquid to a first external location.

2. The system of claim 1, wherein the first flow path comprises a first control valve, and wherein the second flow path comprises a second control valve, such that toggling between the first flow path operation and the second flow path operation comprises adjusting an open position of the first control valve, the second control valve, or both.

3. The system of claim 1, wherein the first external source is configured to provide the liquid in a pressurized state, thereby providing the motive force of the liquid to flow through the system when the external source has a pressure higher than a pressure of the first external location.

4. The system of claim 3, wherein the liquid flowing through the first mixing device, the second mixing device, or both, creates a motive force for the gas to flow through the system.

5. The system of claim 4, wherein the first mixing device, the second mixing device, or both, comprises an orifice that increases a velocity of the liquid, thereby creating a low pressure zone within the first mixing device, the second mixing device, or both, such that a pressure differential between the second external source and the low pressure zone creates the motive force for the gas.

6. The system of claim 5, wherein the first mixing device, the second mixing device, or both, comprises a venturi injector, a venturi valve, a venturi orifice, or any combination thereof.

7. The system of claim 5, wherein the orifice of the first mixing device comprises a cross-sectional area that is from about 0.5 to about 5.0 times in size compared to a cross-sectional area of the orifice of the second mixing device, such that the first flow rate is larger than the second flow rate according to a cross-sectional area size proportional increase in volumetric flow.

8. The system of claim 1, further comprising a control device comprising a chamber configured to receive the treated liquid from the first flow path, the second flow path, or both.

9. The system of claim 8, wherein the control device is in fluidic communication with a treated liquid sensor, the treated liquid sensor configured to detect a property of the treated liquid.

10. The system of claim 9, wherein the property of the treated liquid comprises an oxidation-reduction potential.

11. The system of claim 9, wherein the treated liquid sensor is in communication with a display panel, an LED module, or both, wherein the treated liquid sensor is configured to indicate whether the property of the treated liquid is above a minimum threshold.

12. The system of claim 8, further comprising an output tube fluidly coupling the control device with the first outlet.

13. The system of claim 12, wherein the first flow path is a first portion of the first flow path, and wherein the output tube is a second portion of the first flow path.

14. The system of claim 13, further comprising i) a second outlet for dispensing the treated liquid to a second external location, and ii) an elbow tube fluidly coupling the control device with the second outlet, wherein the second flow path is a first portion of the second flow path, and wherein the elbow tube is a part of a second portion of the second flow path.

15. The system of claim 14, wherein the first portion of the first flow path comprises a first control valve, wherein the first portion of the second flow path comprises a second control valve, and wherein the second portion of the second flow path comprises a third control valve, such that toggling between the first flow path operation and the second flow path operation comprises adjusting an open position of the first control valve, the second control valve, the third control valve, or any combination thereof.

16. The system of claim 15, wherein the first flow path operation comprises i) the first control valve to be in the open position to allow the liquid or the treated liquid to pass therethrough, and ii) the second control valve and the third control valve to be in a closed position to prevent or reduce an amount of the liquid or the treated liquid to pass therethrough.

17. The system of claim 15, wherein the second flow path operation comprises i) the first control valve to be in a closed position to prevent or reduce the liquid or the treated liquid to pass therethrough, and ii) the second control valve and the third control valve to be in the open position to allow the liquid or the treated liquid to pass therethrough.

18. The system of claim 1, wherein the generator comprises a first generator and a second generator fluidly coupled with the first generator, wherein the first generator and the second generator are coupled in series, such that the gas is configured to flow from the second inlet to the first generator to the second generator and then to one or both of the first mixing device and the second mixing device.

19. The system of claim 1, wherein the generator is configured to process the gas by exciting the gas, wherein the gas comprises oxygen, wherein exciting the gas results in at least some of the oxygen to be converted into ozone, such that the processed gas comprises ozone.

20. The system of claim 19, wherein the liquid comprises water, such that the treated liquid comprises ozonated water.
